(19) United States
(12) Patent Application Publication
(10) Pub. No.: US 2026/0044032 A1
(43) Pub. Date: Feb. 12, 2026

(54) RESONANT CAVITY SWITCHING (RCS) AND REFRACTIVE INDEX MODULATING (RIM) DEVICES

(71) Applicant: Blue Laser Fusion, Inc., Palo Alto, CA (US)

(72) Inventors: Srinivas GANDROTHULA, Palo Alto, CA (US); Shuji NAKAMURA, Palo Alto, CA (US)

(21) Appl. No.: 19/297,881

(22) Filed: Aug. 12, 2025

Related U.S. Application Data
(63) Continuation-in-part of application No. 18/799,148, filed on Aug. 9, 2024, now Pat. No. 12,422,600.

(51) Int. Cl. G02F 1/11; G02F 1/015; G02F 1/31

(52) U.S. Cl. CPC G02F 1/11; G02F 1/0151; G02F 1/31; G02F 2203/055; G02F 2203/15

(57) ABSTRACT

A dynamically tunable optical mirror named as a resonant cavity switching (RCS) device and a refractive index modulating (RIM) device are disclosed. The RCS device is comprising a nanoporous piezoelectric III-nitride material layer, such as GaN, AlN, AlScN, AlGaScN or their alloys sandwiched between a high-reflectivity distributed Bragg reflector (DBR) and a lower-reflectivity output DBR. The RIM devise is comprising the nanoporous III-nitride material layer. The nanoporous layer, patterned with interdigital transducers (IDTs), is actuated via surface acoustic waves (SAWs) or electric fields to induce rapid, reversible modulation of its effective refractive index. This enables sub-nanosecond switching between resonant and off-resonant optical states, facilitating efficient energy extraction, optical pulse carving, or phase control.

### CROSS-REFERENCE TO RELATED APPLICATIONS

This application is a continuation-in-part and claims priority to U.S. Ser. No. 18/799,148, filed on Aug. 9, 2024, which is commonly assigned, and hereby incorporated by reference.

### BACKGROUND OF THE INVENTION

The present invention relates generally to energy techniques. In particular, the present invention provides a system and method for transferring energy, related methods, and more particularly techniques for dumping the laser or light (e.g., white light) from a first region to a second region. Merely by way of example, the invention can be applied to a variety of applications, including power, spaceships, travel, other vehicles for air, land, and water, defense applications (e.g., satellite, aerospace, land and missile defense, submarines, boats), biotechnology, chemical, mechanical, electrical, display, switching, and communication and/or data applications.

From the beginning of time, human beings have developed energy sources from natural materials such as wood, coal, oil, and gas products. Unfortunately, burning wood and coal leads to major pollution issues, including adding undesirable carbon particles into the atmosphere. Oil and gas products also have similar limitations and have been a leading cause of “global warming.” Renewable energy sources including nuclear, wind, hydroelectric, and solar are promising. However, such renewable energy sources have other shortcomings. Wind only works if the wind is blowing. Solar cannot be used when the sun goes down. Hydroelectric is limited to areas with water, and nuclear, although promising, has had major problems in generating waste and unreliable and dangerous reactors. One other promising energy source has been fusion energy.

Fusion energy is a type of energy production that occurs when two atomic nuclei fuse together, releasing a large amount of energy in the process. It is considered a potential source of clean and abundant energy, as the fuel for fusion reactions (mainly hydrogen) is abundant on Earth and the reactions produce no greenhouse gases or other harmful pollutants.

There are two main approaches to achieving fusion reactions: inertial confinement fusion (ICF) and magnetic confinement fusion (MCF).

Inertial confinement fusion (ICF) involves using high-energy lasers or particle beams to compress and heat a small pellet of fuel, causing it to fuse. The main advantage of ICF is that it can potentially produce fusion reactions with a relatively small amount of fuel and at a relatively low cost. However, the process is still in the experimental stage and there are significant technical challenges to before it can be considered a desirable source of energy.

Magnetic confinement fusion (MCF) involves using strong magnetic fields to contain and heat a plasma (a hot, ionized gas) of hydrogen fuel, causing it to fuse. The most common type of MCF is called tokamak fusion, which uses a toroidal (doughnut-shaped) chamber to contain the plasma. The plasma is held in the center of the chamber by strong magnetic fields, which are created by running current through a set of coil windings around the chamber. The plasma is heated by injecting energy into it, either through particle beams or through electromagnetic waves.

The main advantage of MCF is that it has the potential to produce fusion reactions on a larger scale, making it more suitable for generating electricity. However, it is a more complex and costly process than ICF and there are still significant technical challenges to overcome before it can be considered a desirable source of energy.

Both ICF and MCF have made significant progress in recent years and there are several experimental facilities around the world working on these technologies. However, achieving sustained fusion reactions with net energy production (meaning the energy produced by the fusion reactions is greater than the energy required to initiate and sustain the reactions) remains a major technical challenge.

There are also other approaches to fusion energy being explored, such as magnetized target fusion and muon-catalyzed fusion. However, these approaches are still in the early stages of development. It is not yet clear if fusion energy will be viable as a source of energy.

From the above, fusion energy has the potential to be a clean and abundant source of energy, but significant technical challenges must be overcome before it can be considered a practical source of energy.

### SUMMARY OF THE INVENTION

The present invention describes a fabrication methodology and device architecture for a dynamically tunable optical mirror of resonant cavity switching (RCS) device that incorporates a nanoporous piezoelectric material layer as the core resonant medium. The mirror structure comprises of three desirable functional components: (1) a high-reflectivity distributed Bragg reflector (DBR) serving as the back mirror, (2) a central cavity layer composed of a void-engineered piezoelectric material with an optical thickness equal to an odd multiple of λ/(2n), and (3) a front DBR with deliberately lower reflectivity to facilitate energy extraction effectively wherein n is the effective refractive index of nanoporous piezoelectric material layer. This asymmetric reflectivity configuration is fundamental to the mirror's operational mode, supporting initial energy confinement and subsequently enabling on-demand energy release through resonance tuning. Alternatively, one may use a symmetric configuration but to improve efficiency asymmetry induced in the DBRs of RCS device. The symmetric configuration of mirror reflectivity is also included in the present invention.

The cavity layer may be formed from III-nitride-based piezoelectric materials such as GaN, AlN, ZnO, or quaternary alloys like GaAlScN. These materials are initially deposited using epitaxial techniques (e.g., MOCVD) or physical methods (e.g., RF sputtering, IBD), resulting in dense, optically active films. Subsequent porosification achieved via electrochemical etching transforms the film into a nanostructured material with reduced effective refractive index and enhanced acoustic or electric field sensitivity to change the refractive index. The engineered voids are not residual artifacts but a critical design feature: they enable spatially distributed refractive index modulation under excitation, while preserving high transparency, wide bandgap optical access, and robust thermal and fluence handling. These voids, holes, nano tubes, nano hole or pores could be formed using dry or wet etching after making nano mask or any kinds masks. In another approach, a porous matrix can be formed by mixing two materials that undergo crosslinking, after which one of the materials is dissolved in a compatible solvent, leaving behind a pore or hole matrix in the desired material. The thickness of nanoporous piezoelectric cavity layer is (2m+1)λ/2n_{zero} without the energy and (2m+1)λ/2nᵣ, with the energy where m is an integer; m=0, 1,2 - - - , λ is the operating wavelength, and n_{zero} and nᵣ is the effective refractive index without and with energy into the cavity layer, respectively. The value of m is smaller the better in the view of the response time of the RCS device.

To achieve tunability, lithographically defined electrodes or interdigital transducers (IDTs) are integrated directly on or near the porous layer. These transducers are used to launch acoustic waves such as surface acoustic waves (SAWs) and bulk acoustic waves (BAW) or apply direct electrical bias inducing localized strain fields within the cavity. Due to the random crystalline orientation of the pores and their volumetric distribution, the SAW amplitude experiences direction-specific enhancement, triggering localized perturbations and in some cases, transient pore refilling. This results in a temporally controlled change in the cavity's effective optical path length through modulation of the product of refractive index and physical thickness (nᵣ d), where n, is the resulting refractive index when applied external field and d is the thickness of the cavity layer.

In the case of applying an electric field, due to the piezoelectricity, the volume of piezoelectric material which has the refractive index of about 2.5 (in the case of dense GaN) is increased or decreased by applying a modulated electric field, the volume of each pore which region has a refractive index of 1.0 is varied, and then the effective refractive index of the cavity layer is changed dramatically through the change of the volumes of the pore regions. If no pore regions in the cavity layer of the piezoelectric material, almost no changes of the refractive index. Using the SAW or BAW, the volume of each pore which region has a refractive index of 1.0 is varied, and then the effective refractive index of the whole cavity layer is changed dramatically through the change of the volumes of the pore regions. Additionally, this process is a reversible process that means the change is momentary and returns to the original when external field is removed.

In the default state, the high-reflectivity back DBR of RCS device prevents the optical field from entering the cavity, maintaining the system in an off-resonant, highly reflective condition. Upon activation, the strain-induced refractive index shift tunes the porous cavity layer into resonance with the incident wavelength, enabling energy transfer into the cavity and subsequent directional extraction through the front, partially reflective DBR.

This structure supports both integrated and large-area implementations. While compatible with on-chip photonic platforms, the invention is not limited to chip-scale deployment; the RCS device can be mounted in free-space optical systems and scaled to apertures needed for LiDAR, remote ignition, pulsed fusion drivers, or reconfigurable mirror arrays in laser power architectures.

By embedding RCS device, index tunability, and directional optical coupling into a single monolithic mirror element, present invention overcomes the core limitations of conventional tunable optics eliminating the need for external phase modulators, high-voltage crystals, or slow thermal mechanisms. The result is a multifunctional optical interface that enables ultrafast modulation, gated signal release, and coherent energy extraction within a unified, tunable mirror architecture.

A further understanding of the nature and advantages of the invention may be realized by reference to the latter portions of the specification and attached drawings.

### BRIEF DESCRIPTION OF DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings in which:

FIG. 1A is a simplified schematic of RCS device structure using a piezoelectric nanoporous III-nitride layer (cavity layer) sandwiched between asymmetric DBRs according to an example of the present invention. (Illustrates the core resonant cavity architecture, where a piezoelectrically active nanoporous III-nitride layer is positioned between a high-reflectivity shared DBR and a lower-reflectivity output DBR. Acoustic waves or electric fields modulate the refractive index to enable sub-nanosecond optical switching.)

FIG. 1B is a simplified illustration of an as deposited piezo layer without pores and an annealed piezo layer with pores according to an example of the present invention.

FIG. 2 is a simplified illustration of an electrode and pore placement structure showing static and shifted actuation states, including a default placement of IDT and pore distribution; and a shifted alignment between pores and IDT electrodes, according to an example of the present invention.

FIG. 3 is a simplified diagram of a suspended Membrane RCS device, including a micromachined membrane cavity formed across a substrate aperture, according to an example of the present invention.

FIG. 4 is a simplified diagram of a modular RCS device according to an example of the present invention, including a standalone cavity block comprising tunable RCS structure, integrated electrodes, and interface layers for system-level assembly or packaging, according to an example of the present invention.

FIG. 5 is a simplified diagram of a scalable array of RCS devices, including multiple cavity units arranged in a 1D or 2D array, according to an example of the present invention.

FIG. 6 is a simplified diagram of an integrated energy release from an optical enhancement cavity (OEC) via RCS output coupling, including a displays a configuration where energy stored in a OEC cavity is selectively extracted through RCS device upon activation, enabling coherent, directional energy delivery, according to an example of the present invention.

FIG. 7 is a simplified diagram of a multi-RCS device network for directed energy applications in nuclear fusion systems according to an example of the present invention.

FIG. 8A is a simplified diagram illustrating an operational principle of RCS device, with blue LED as an example of the present invention.

FIG. 8B is a simplified diagram illustrating schematics for green, blue and red RCS devices shown along with spectrums according to an example of the present invention.

FIG. 8C is a simplified diagram illustrating a schematic of using RCS devices with green, blue, and red light sources, or a white light source, to project images according to an example of the present invention.

FIG. 8D is a simplified illustration of an AR glasses application demonstrating the functionality of the RCS device according to an example of the present invention.

FIG. 8E is a simplified illustration of RCS device applications in VR and AR screens according to an example of the present invention.

FIG. 8F is a simplified diagram of an AR application with glasses embedded with waveguides to display images from green, blue, and red light sources, each coupled to its respective waveguide according to an example of the present invention.

FIG. 8G is a schematic illustration of RCS device applications, in direct viewing screens ranging from watch displays to large billboards according to an example of the present invention.

FIG. 8H is a simplified illustration of projection system is shown with RCS devices according to an example of the present invention.

FIG. 8I is a simplified diagram of an illustration application of head up display application in an automobile with RCS devices according to an example of the present invention.

FIG. 9 is a simplified illustration of an RCS device application in LiDAR Systems: Illustrates Q-switching and pulse generation using RCS device for automotive or drone navigation according to an example of the present invention.

FIG. 10 is a simplified diagram of a cavity quantum electrodynamics (cQED)-Compatible RCS structures for quantum photonic applications: Demonstrates integration with quantum emitters for deterministic single-photon release, quantum key distribution, or photon entanglement through dynamic cavity tuning according to an example of the present invention.

FIG. 11 is a simplified diagram of an ultrafast pulse shaping applications of RCS device: explains dynamic temporal modulation and pulse shaping for applications in ultrafast optics, according to an example of the present invention.

FIG. 12 is a simplified diagram of a remote optical ignition and ablation using high-peak-power pulses from RCS Structure, including a laser pulse delivery through fiber or free-space to ignite fuel, initiate plasma, or ablate materials in sealed, hazardous, or inaccessible environments according to an example of the present invention.

FIG. 13A is a simplified tunable RCS arrays arranged in parallel for optical multiplexing and demultiplexing in data transfer or beam steering systems according to an example of the present invention.

FIG. 13B is a simplified diagram of a tunable single RCS unit for optical multiplexing and demultiplexing in data transfer or beam steering systems according to an example of the present invention.

FIG. 14 is a simplified diagram of an RCS design adapted to solid-core and hollow-core fiber interfaces for pulse control applications according to an example of the present invention.

FIG. 15 is a simplified diagram of RCS devices architecture for optical communication networks according to an example of the present invention.

FIG. 16 is a simplified diagram of an RCS device architecture for tissue scanning in medical applications according to an example of the present invention.

FIG. 17A is a simplified schematic of RCS device for satellite free space optical communication with a single mode operation according to an example of the present invention.

FIG. 17B is a simplified diagram of an architecture of RCS device for satellite free space optical communication with a multichannel data activation according to an example of the present invention.

FIG. 18 is a simplified diagram of refractive index modulations (RIM) device 1801 illuminated by an input laser beam at a reference wavelength 1802, whereupon upon activation of the RIM device, the output beam 1804 is phase-shifted relative to the reference wavelength, with the induced phase difference indicated as 1803 according to an example of the present invention.

FIG. 19 is a simplified diagram of a facet-Integrated RIM device for tunable single-mode operation in III-V compound semiconductor lasers according to an example of the present invention.

FIG. 20 is a simplified diagram of (A) an RCS device configuration for generating single photon with a quantum dot embedded LED; and (B) RIM device architecture to generate single photon with quantum dot embedded LED according to an example of the present invention.

### DETAILED DESCRIPTION OF THE EXAMPLES

The present invention relates to the design and fabrication of resonant cavity switching (RCS) devices that integrate a porous piezoelectric material, in particular III-nitride material layer, such as GaN, AlN, or GaAlScN, among others, positioned between two distributed Bragg reflector (DBR) stacks. This multilayer structure forms a functional resonant-cavity mirror whose optical properties including reflectivity, spectral position, phase response, and transmission can be actively modulated through electrical, piezoelectric, or acoustic excitation or external energy. Unlike conventional fixed DBR coatings or passive mirror layers, the proposed structure acts as a reconfigurable photonic element, enabling sub-nanosecond control of resonance conditions for purposes such as optical switching, on-demand energy release, spectral tuning, pulse shaping, intensity control, wavelength separation, phase modulation, and cavity dumper. Alternatively, on the central pore or void containing layer alone without DBR stacks on either side, refractive index modulation can be performed to change several light matter interactions, we call the device as refractive index modulation (RIM) device.

In an example, a dynamically controlled RCS device is highly applicable to a broad range of advanced photonic systems requiring real-time, programmable control over optical resonance conditions. These include ultrafast pulsed lasers [1], optical modulators for quantum photonics [2], reconfigurable LiDAR arrays [3], on-chip laser steering and signal routing [4], adaptive optics [5], and high-speed optical memory or feedback networks [6]. In all these applications, the ability to shift the resonant condition of an optical cavity with high temporal precision without degrading finesse, spatial coherence, or cavity stability is desirable to performance and scalability.

Importantly, because the spectral linewidth (full-width at half-maximum, FWHM) of high-finesse optical cavities typically ranges from 1 μm to 1 nm [7], only modest changes in the effective refractive index on the order of Δn˜0.005 to 0.5 is sufficient to shift the cavity resonance by picometer to several nanometers, thus achieving full spectral alignment or detuning relative to another optical channel. This level of modulation is well within the capabilities of the present invention, which achieves refractive index tuning through the interaction of surface acoustic waves (SAWs), bulk acoustic waves or electric fields or external energy with randomly oriented nanopores embedded in the piezoelectric material layer. Alternatively, one may use this invention to tune systematically patterned pores of random or same sizes. As the acoustic wavefront or electric field propagates through the porous matrix, anisotropic strain enhancement due to the local crystallographic orientation of pores results in volumetric deformation and localized dielectric changes. In some instances, transient pore filling or compression further amplifies this effect, producing dynamic index modulation with high temporal resolution and spatial uniformity.

By comparison, conventional commercial technologies suffer from severe trade-offs. Electro-optic modulators (EOMs) based on Pockels materials such as lithium niobate offer only Δn˜10⁻⁴ to 10⁻³, requiring long interaction lengths and high drive voltages [8]. Acousto-optic modulators (AOMs) rely on bulk diffraction and are limited by acoustic latency and device geometry [9]. Thermo-optic modulators in silicon photonics provide larger index shifts but are fundamentally limited by millisecond response times and significant thermal dissipation (>50 mW) [10]. Furthermore, none of these conventional tools are optimized for tuning resonance conditions inside an optical cavity with the timing precision or high spectral selectivity needed for coherent energy transfer, cavity QED systems, or multi-channel laser control.

The present invention uniquely enables tunable cavity mirrors capable of precisely controlling optical resonance through dynamically reconfigurable refractive index modulation. This is achieved in a monolithic, process-compatible structure based on electrochemically etched porous III-nitride layers and integrated acoustic actuation or electric field biased actuation. The RCS device could open pathways toward programmable cavity networks, ultrafast optical switching, and high-speed signal modulation without reliance on bulky or lossy external modulators.

A conventional Electro-Optic Modulator (EOM) is a device that controls the properties of light, such as its intensity, phase, or polarization, using an applied electrical voltage. EOMs use an electro-optic effect, where the refractive index of a material changes in response to an electric field. This allows for precise and dynamic control of light, making them desirable components in various applications like telecommunications, laser systems, and scientific research. The change in refractive index (Δn) in an Electro-Optic Modulator (EOM) depends on the electro-optic coefficient of the material, the applied voltage, and the geometry of the modulator. The change is typically small, on the order of 10 5 to 10⁻⁴. Example: Lithium Niobate (LiNbO₃). For 10 V across a 10 μm crystal, Δn≈−1.6×10⁻⁴. Single crystal Lithium Niobate (LiNbO₃) is required for EOM application. Due to the single crystal growth and the processing of the crystal, the cost of EOM is very expensive. The present invention of RCS device is much cheaper, and any size from smaller than 1 micron up to 1 meter could be realized because the materials of RCS device are deposited by sputtering, physical vapor deposition (PVD) or a conventional thin film deposition system.

High-reflectivity mirrors are foundational elements in a wide array of optical systems requiring energy buildup, phase control, or cavity feedback, such as laser resonators, interferometers, optical delay lines, and nonlinear up-conversion cavities. These systems conventionally rely on static distributed Bragg reflector (DBR) pairs, typically fabricated from dielectric or semiconductor multilayers, achieving reflectivity exceeding 99.9%. In many designs, particularly in Q-switched lasers or cavity-enhanced spectroscopy, one of the mirrors is engineered with slightly lower reflectivity (e.g., 98-99.5%) to permit controlled energy outcoupling. However, this introduces a fixed output-coupling ratio, limiting operational flexibility. These systems cannot dynamically modulate throughput, adapt to real-time trigger conditions, or reconfigure energy extraction on sub-nanosecond timescales, constraints that increasingly hinder modern applications such as quantum photonics, optical fusion, and integrated reconfigurable optics.

Conventional optical modulators and tunable mirror systems face trade-offs between speed, integration, tuning range, cost and physical footprint. Thermo-optic modulators, based on localized heating of waveguide or resonator structures, offer modest refractive index modulation but suffer from millisecond-order response times and continuous large power consumption. EOMs typically using the Pockels effect in lithium niobate, achieve sub-nanosecond speed but require high drive voltages and device lengths of several centimeters to achieve appreciable phase shifts. The change of refractive index is typically very small, on the order of 10⁻⁵ to 10⁻⁴.

An Acousto-Optic Modulator (AOM) is a device that uses sound waves to modulate a laser beam's properties most commonly its intensity, frequency, phase, or direction. It works by using the acousto-optic effect, where an acoustic wave traveling through a crystal creates a periodic change in the refractive index, acting like a moving diffraction grating for light. AOMs which rely on bulk diffraction through crystals, offer dynamic beam steering but necessitate long interaction paths and introduce diffractive walk-off and latency due to acoustic transit times. None of these technologies provide the combined benefits of GHz-scale modulation speed, structural robustness, and real-time cavity finesse control that are now required for scalable optical systems. Surface Acoustic Wave (SAW) devices rely on materials that support efficient acoustic wave propagation on the surface and, ideally, have piezoelectric properties to convert electrical signals into mechanical waves and vice versa.

Advances in porous and void-containing materials, especially wide-bandgap piezoelectric alloys such as GaN, AlN, AlGaN, GaAlScN and ZnO have created opportunities for embedded cavity tuning. Among these, quaternary alloys such as GaAlScN (gallium-aluminum-scandium nitride) offer unique advantages. The incorporation of scandium into the III-nitride matrix increases the piezoelectric coefficient and acoustic displacement sensitivity, while maintaining high thermal stability, wide bandgap transparency, and compatibility with standard epitaxial growth techniques. Moreover, GaAlScN retains the ability to form stable, controllable porosity through electrochemical etching, making it ideal for use as a dynamic index-tunable cavity medium in the present invention described herein. Alternatively any alloy made of Ga, Al, Sc, N, In alloy, among others, could generate a significant refractive index tuning. Throughout the invention we have given GaN as an example, however any of the above alloys still hold the same.

When engineered with controlled nanoscale porosity (e.g., 10-60% void fraction), these materials exhibit significantly reduced effective refractive indices due to a region of many voids with a refractive index of 1 while retaining high optical transparency and strong piezoelectric response. Their refractive index becomes dynamically tunable under externally applied strain fields, particularly those induced by surface acoustic waves (SAWs) generated using lithographically patterned interdigital transducers (IDTs) or electric field. This enables ultrafast, effective refractive index changes of the porous piezoelectric material on the order of Δn˜0.005-0.5, which value is much higher than Δn˜10⁻⁵-10⁻⁴ of Lithium Niobate (LiNbO₃) mentioned above and is sufficient to shift the resonant condition of high-finesse cavities by several nanometers. Since typical cavity linewidths range from 1 picometer to several nanometers, even small modulations in refractive index are enough to switch the cavity into or out of resonance with the incoming optical field, thereby triggering energy release or phase modulation with sub-nanosecond timing precision.

The present invention of RCS device uses these effects by embedding a nanoporous piezoelectric III-nitride layer, optionally GaAlScN, between two DBRs of differing reflectivity. Also, instead of semiconductor material just a piezoelectric material with voids or pores would be fine too. The resulting tunable resonant mirror operates as both a high-finesse optical resonator and an ultrafast modulator, switch, or cavity coupler, or a selective wavelength transmitter, also a component to produce a tunable laser. When the cavity is tuned to match the optical carrier such as a laser, energy of laser is selectively extracted through the lower-reflectivity DBR. When detuned, the mirror returns to a highly reflective state. In an example, dynamic control is embedded directly within the mirror's structure and can be triggered either acoustically or electrically.

Importantly, the present invention is not restricted to chip-scale photonic circuits. The same sandwich architecture of porous piezoelectric material and DBR stacks can be scaled to large apertures and bonded to free-space optical subsystems, including telescope mirrors, optical delay modules, or high-energy beam steering systems, wherever ultrafast, programmable resonance control is required. This flexibility allows the invention to support both integrated and discrete optical architectures, ranging from on-chip quantum networks to macro-scale laser ignition systems or high-fluence fusion optics.

By replacing fixed-coupling reflectors and external modulators with a single integrated, dynamically reconfigurable mirror structure, the invention redefines how resonance tuning, energy extraction, and phase control can be implemented in modern optical systems. It enables next-generation photonic architectures that are faster, more adaptable, and inherently scalable across physical platforms, from wafer-level packaging to standalone, field-deployable optical components.

Further details of the present invention can be found throughout the present specification and more particularly below.

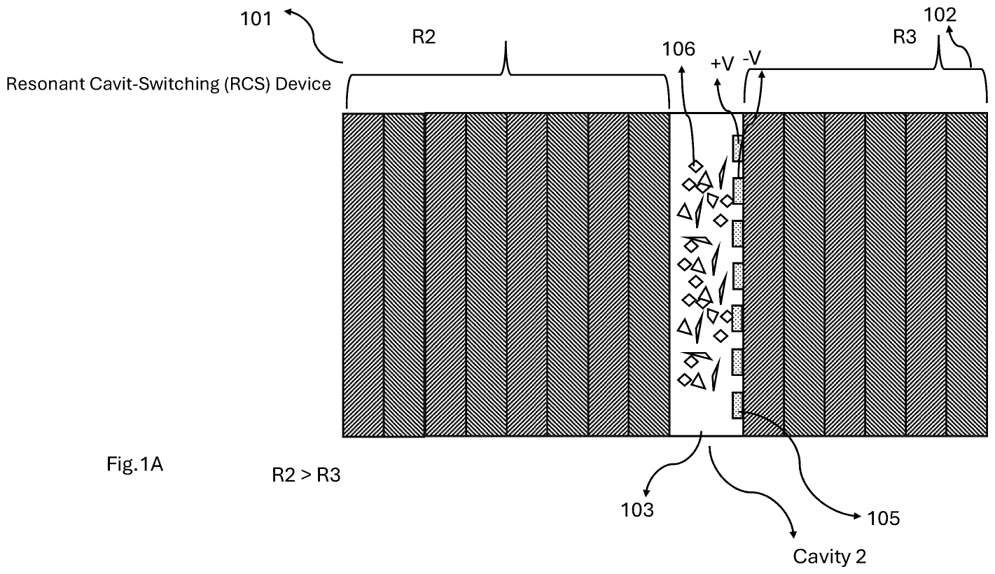

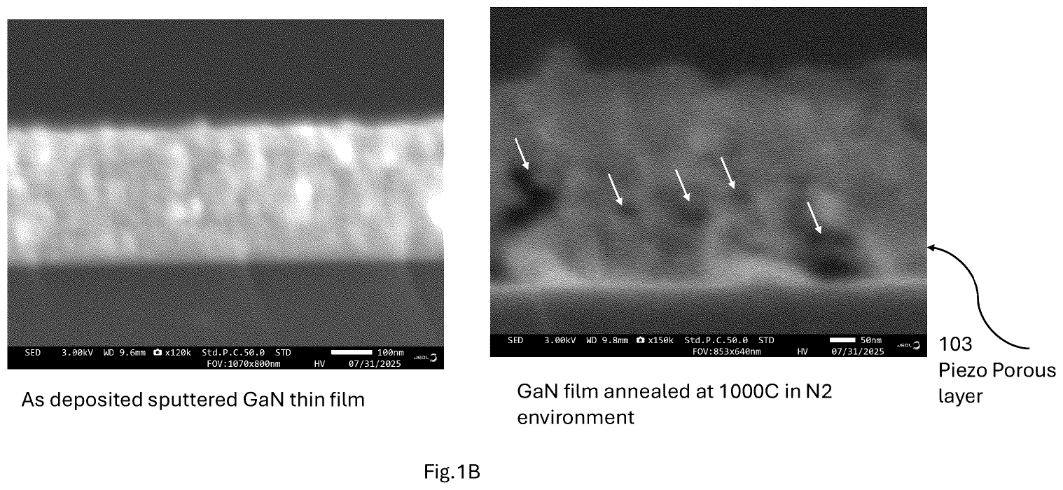

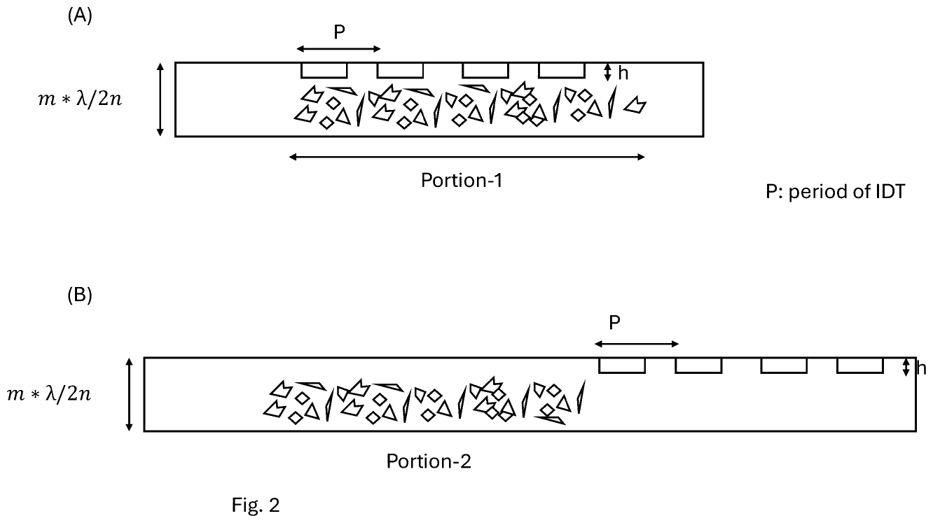

In an example, we present a detailed process for the fabrication of porous III-nitride material layers specifically engineered for use in dynamically tunable RCS devices. These RCS devices are optimized or adjusted for operating in any wavelength range and serve as desirable components in high-finesse or low finess photonic systems, including optical enhancement cavities (OECs), ultrafast Q-switching laser resonators, LiDAR emitters, quantum photonic modulators, telecommunication, AI datacenters, rack to rack communications, AR/VR and projection applications. The RCS architecture incorporates a central nanoporous III-nitride layer (cavity layer), such as GaN, AlN, AlGaN, or GaAlScN (and other materials) sandwiched between two distributed Bragg reflector (DBR) stacks with asymmetric reflectivity as shown in FIG. 1. In FIG. 1, the piezo-porous layer 103, containing nano-sized pores, voids, or holes of random shape or same shape made by mask and integrated with IDTs on one of its surfaces is sandwiched between two DBRs: a high-reflectivity shared-side mirror 101 and a low-reflectivity output-side mirror 102. The electrodes on the piezo-porous layer are preferably positioned on the output-side DBR, near the electric field node region, to minimize optical absorption. This configuration enables coherent energy modulation or extraction on sub-nanosecond timescales by dynamically tuning the refractive index of the porous layer through piezoelectricity or strain-induced effects. FIG. 2 further illustrates the electrode placement relative to the voids. In configuration (A), the electrodes directly face the voids, whereas in configuration (B), the electrodes are positioned away from the void-facing side of the layer to minimize interaction with the incoming electromagnetic energy of the laser.

The choice of III-nitride materials, particularly GaN and its alloys with Al, Sc, or In, stems from their desirable combination of wide bandgap (e.g., up to ˜6.2 eV for AlN), high chemical and thermal stability, and strong piezoelectric and spontaneous polarization characteristics. Among these, GaAlScN has recently emerged as a particularly promising candidate due to its enhanced piezoelectric coefficients and tunable mechanical properties resulting from scandium substitution in the wurtzite lattice. For example, at ˜40% Sc incorporation, GaAlScN exhibits a piezoelectric constant e31 approximately −80° C./m² 50 times higher than that of pure AlN (−1.6 C/m²). These enhanced piezoelectric properties are critical for enabling effective refractive index modulation in response to strain fields generated by surface acoustic waves (SAWs) or applied electrical signals. Additionally, GaAlScN offers superior acoustic impedance matching, providing finer control over modulation speed and bandwidth.

In an example, an initial step in creating the nanoporous structure involves deposition of a Si-doped III-nitride layer, typically 100-500 nm thick. This layer is grown using methods tailored for the target application and fabrication scale. Metal-organic chemical vapor deposition (MOCVD) enables the growth of high-quality epitaxial films with precise control over alloy composition and thickness, making it well suited for applications requiring high optical performance. Sputtering techniques, including DC and RF plasma-enhanced (PE) physical vapor deposition (PVD), are also widely used and are capable of depositing GaAlScN films on larger substrates (e.g., 4-6 inch wafers) with growth rates around 200 nm/hr. Ion beam deposition (IBD) and electron cyclotron resonance (ECR) plasma tools are often used to deposit ultrathin dielectric or conductive layers such as ITO, Si₃N₄, or Al₂O₃, which serve as surface passivation or etch masks. Prior to electrochemical porosification, the doped layer is typically capped with a thin undoped III-nitride layer (1-50 nm), plasma-enhanced chemical vapor deposition PECVD-grown SiO₂, or a conductive ITO film to protect the surface and improve pore uniformity. Here, we call DC, RF sputtering, IBD, ECR and PVD as PVD.

Porosity is introduced through electrochemical etching, wherein the sample is immersed in a dilute acidic electrolyte such as 0.3-0.5 M oxalic acid, nitric acid or hydrochloric acid. A bias voltage of 1-20 V is applied across the sample with a platinum counter electrode, while current densities are maintained between 2-10 mA/cm². Under these conditions, anodic dissolution proceeds preferentially along dislocation sites and grain boundaries, leading to the formation of vertically aligned nanopores. To suppress Rayleigh scattering and ensure low optical loss at wavelengths of 1040-1080 nm, the pore diameter is controlled in the range of 5-30 nm, with inter-pore spacing below 50 nm. Alternatively, the voids or pores can be fabricated with or without chemical etching to make the size of the voids and pores the same. RCS device is used for a light with a wavelength range of, e.g., 300 nm to 3000 nm. The pore diameter is controlled depending on the wavelength of the light.

Alternatively, as illustrated in FIG. 1B, porosity in the piezoelectric layer can also be achieved through controlled annealing conditions. After deposition of the piezoelectric film, the layer may be porosified in a controlled environment, offering compatibility with large-scale manufacturing. As shown in FIG. 1B, the as-deposited layer exhibits no visible porosity; however, annealing the layer in a nitrogen environment at 1000° C. results in the formation of nanoscale pores typically on the order of 100 nm or smaller distributed throughout the layer.

Further optimization may enable uniform pore formation across the entire thickness of the film. In another approach, a multilayer configuration may be used, where two differently conditioned layers are sequentially deposited: one layer is selectively porosified while the other serves as a protective or capping layer, thereby preserving high surface quality.

The porosification process is driven by recrystallization dynamics in the presence of reactive or inert gases, which may also act as mild etching agents. Piezoelectric films deposited by methods such as chemical vapor deposition (CVD), plasma-enhanced CVD (PECVD), or sputtering often in a polycrystalline state can undergo microstructural rearrangement under annealing, resulting in the formation of nanoscopic pores within the film

The resulting porosity levels, typically between 10% and 60%, reduce the effective refractive index from its original value of 2.5 (for example, in dense GaN) to a tunable range between 1.9 and 2.1. This effective refractive index shift is sufficient to modulate the resonance condition of a Fabry-Perot cavity or laser light with a bandwidth as narrow as 1 μm to several nanometers. In practice, an effective refractive index changes as small as Δn=0.005 is sufficient to shift a λ/2n (n: effective refractive index of porous cavity layer) optical cavity into or out of resonance, enabling dynamic control of light transmission or reflection using very small strain amplitudes. In the case visible LEDs used for displays, the emission spectrum is relatively broad. Consequently, a larger effective refractive index change (0.3 or up to 0.5) is typically required to achieve a wavelength shift of 20 nm. However, by incorporating optical filters to narrow the emission peak, the required wavelength shift can be reduced to less than 20 nm. This, in turn, lowers the necessary refractive index change to below 0.3, even for broad spectrum LEDs, through the use of such filter combinations. While maintaining high efficiency which cannot be achieved using LCD displays or OLEDs or micro LEDs.

For examples, the present invention of RCS device as a cavity dumper for optical enhancement cavity (OEC) is mentioned below. The OEC is composed of two mirrors to form the Fabry-Perot cavity. First mirror is a front mirror where the input laser irradiated from the backside of the front mirror, and the laser beam penetrates into the Fabry-Perot cavity through the front mirror. Second mirror of RCS device is a rear mirror where the enhanced laser beam is extracted through the rear mirror of RCS device, which works as a cavity dumper. Both mirrors are high reflection mirrors of more than 99.999% for 150 m OEC. The reflectivity could be different between two mirrors to improve the efficiency of the OEC to extract the enhanced laser beam.

The cavity dumper device, RCS device, used on the rear mirror of OEC is composed of a porous piezoelectric material layer sandwiched by two distributed Bragg Reflectors (DBRs). During the OEC operation, the rear mirror of the cavity dumper of RCS device works as a high reflection mirror (of more than 99.999% mirror for 150 m OEC) to enhance the laser beam inside of the cavity. When the enhanced laser beam is extracted, an electric power or external energy is applied to the porous piezoelectric material layer, the effective refractive index of n is changed from n_{zero} to nᵣ, the optical path of the porous piezoelectric material layer becomes λ/(2nᵣ) from λ/(2n_{zero}), the laser beam resonates with the cavity dumper of RCS device, and then the reflectivity for the laser wavelength is changed from a high reflectivity of 99.999% to a low reflectivity lower than 20%. λ corresponds to the laser wavelength. n is the effective refractive index of the porous piezoelectric material layer. n_{zero} is the effective refractive index of the porous piezoelectric material layer without the electric field or the acoustic waves or external energy. nᵣ is the effective refractive index of the porous piezoelectric material layer with the electric field or the acoustic waves or the external energy.

To enable dynamic modulation, interdigital transducers (IDTs) are lithographically patterned or electron beam patterning onto the porous layer to launch SAWs. These SAWs generate periodic tensile and compressive strain fields, which modulate the local refractive index not only through the photo-elastic effect but also via dynamic pore filling and deformation, as strain-induced pressure locally modifies the pore volume and material density. Reported SAW velocities in various III-nitride materials include 5600-5800 m/s for AlN, 3900-4200 m/s for GaN, and 3600-4000 m/s for AlScN with Sc content between 10-30% [11].

For a λ/(2n) cavity using a GaN layer in an RCS device operating at 1064 nm, with the effective refractive index of the porosified GaN reduced to 2.1, the physical thickness is approximately 253 nm. Assuming a representative SAW velocity of 4000 m/s, the switching time (τ=L/v) is about 63 ps, well below 100 ps. This performance far surpasses conventional electro-optic modulators based on LiNbO₃ (1-3 ns) and bulk acousto-optic modulators (10 ns or more), enabling unprecedented modulation speed and precision.

Maintaining low optical loss is desirable to preserve the high-Q behavior of these mirrors. Al-rich III-nitrides exhibit extremely low absorption at 1040-1080 nm due to their wide bandgap properties. Reported absorption coefficients are <10 cm⁻¹ for Al_{0.6}Ga_{0.4}N at 1064 nm and <3 cm 1 for high-purity AlN or AlScN after annealing [12]. Nevertheless, the electrochemical etching process may introduce mid-gap surface states that increase sub-bandgap absorption. This is mitigated through post-etch annealing in forming gas (H₂/N₂) at temperatures of 600-800° C., which passivates dangling bonds and restores optical clarity. For long-term stability and environmental resistance, an additional atomic layer deposition (ALD) coating of Al₂O₃ (typically 5-20 nm) can be applied to seal the surface.

The described fabrication process supports wafer-scale manufacturing with excellent control over material quality and structural uniformity. Typicaly±2% thickness control across 4-inch wafers and etch depth uniformity within ±10 nm can be achieved. The technology is compatible with a range of substrates including sapphire, silicon, silicon carbide (SiC), and fused silica, offering broad applicability to both photonic integrated circuits (PICs) and large-scale free-space optical systems.

There have been challenges in display applications using visible wavelengths, specifically blue (450 nm), green (532 nm), and red (638 nm). Blue and green active regions can be fabricated using InGaN alloys; however, red emission still predominantly relies on AlInGaP-based alloys, which complicates integration. Depending on resolution requirements, some displays utilize micro-LED arrays, where thousands to millions of tiny light-emitting diodes are individually mounted on electrically excitable substrates. The assembly of each microscopic pixel for a single color is labor-intensive and costly.

Laser-based display systems, which scan RGB laser beams to create images, present additional complexity, requiring bulky optics and precise scanning mechanisms. Other solutions, such as LCOS (liquid-crystal-on-silicon) and LCD (liquid crystal display) panels, suffer from polarization and color-filter losses, often reducing efficiency to below 5%. OLED screens, while compact, face issues such as permanent pixel burn-in and latency.

Resolution and spectral bandwidth also differ among technologies: LEDs typically exhibit a full width at half maximum (FWHM) of ˜20 nm, lasers about 1-2 nm, and DFB lasers achieve sub-nanometer linewidths. However, reaching these narrower linewidths significantly increases device complexity and manufacturing cost.

The present invention, incorporating the resonant-cavity switching (RCS) device, overcomes these limitations by providing a single, reconfigurable platform capable of replacing these disparate elements. Through dynamic refractive index tuning and narrowband spectral control, the RCS device can deliver sub-nanometer emission bandwidth, high efficiency, and simplified integration-without the complexity associated with conventional LED, laser, or OLED-based display systems.

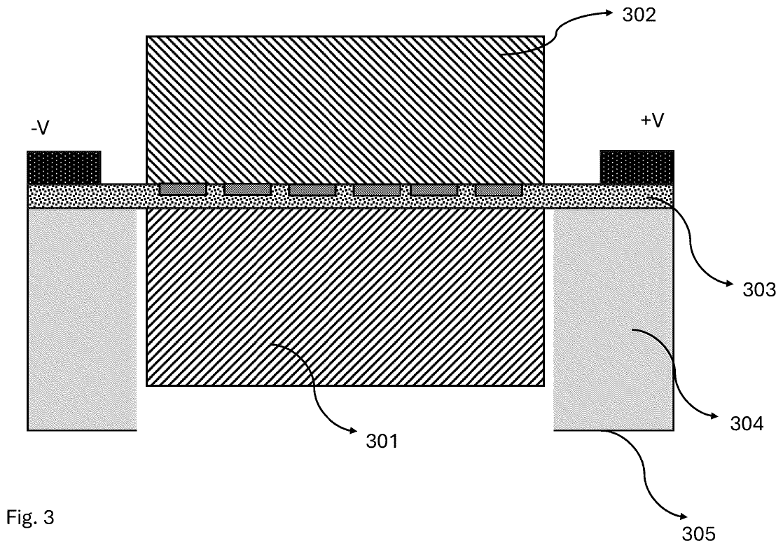

For certain applications, as shown in FIG. 3, the RCS device structure can be implemented as a suspended membrane across a micromachined aperture in the substrate 304, with a porous layer 303 embedded between two dielectric DBR mirrors 301 and 302. The surface 305 can serve as an adaptor for coupling to fiber-based cavities or for use in modular photonic applications. This membrane-style design enables improved thermal dissipation, reduced acoustic clamping, and higher modulation bandwidths. Such implementations are also compatible with integration into micro-opto-electro-mechanical systems (MOEMS), enabling co-packaging with RF, control electronics, and optical interconnects.

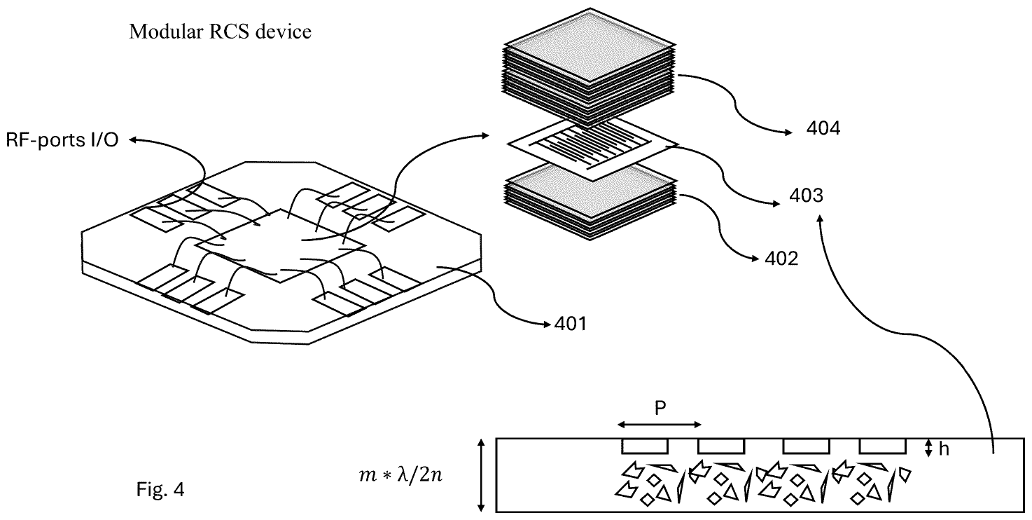

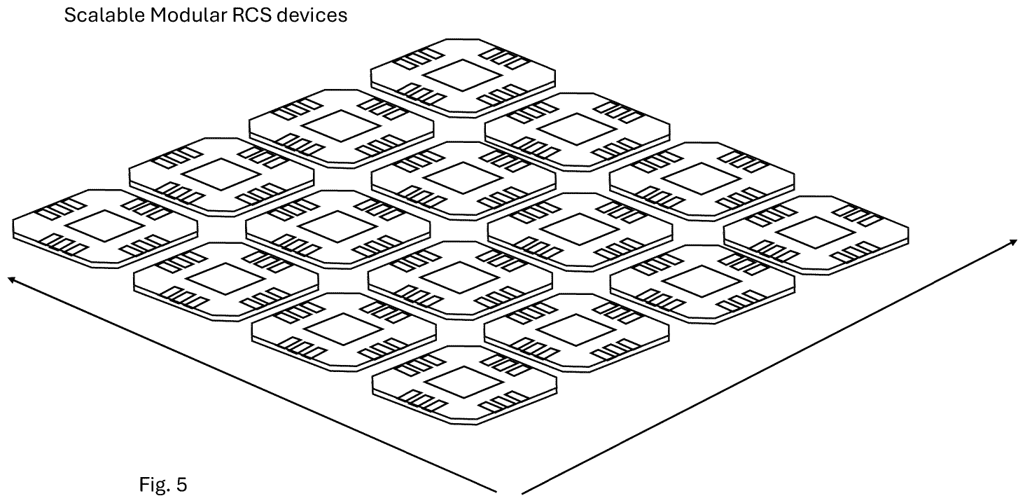

A modular RCS device structure, as illustrated in FIG. 4, is fabricated on a transparent substrate 401 such as glass, fused silica, or any compatible optical material. The fabrication process begins with the deposition of a first dielectric DBR mirror. A piezoelectric material layer is then deposited on top of this mirror and subsequently transformed into a porous piezoelectric layer through a controlled porosification process, 403. This piezo-porous layer supports the integration of various IDT or electrical contact configurations designed to maximize the effect of pore filling. Surface acoustic waves (SAWs), bulk acoustic waves (BAWs) or electric field are focused into the porous region, dynamically modulating the refractive index through both strain-induced effects and partial pore refilling. While IDTs may be placed on a single side, FIG. 4 shows an example with IDTs on all four sides; this configuration is optional and can be tailored for specific application needs. In the case of electric field used for piezoelectricity, the conventional electrode and contact such as two electrical pads on front and back surface of the porous layer are fine too instead of IDT. Then the DBR mirror 404 for output coupling is placed. The reflectivity of DBR 404 should be smaller than that of first DBR 402 to increase the efficiency of RCS device output. This side goes to the side to release energy. The magnified image of the layer 403 also shown in FIG. 4. These compact modular cavity units can be scaled into two-dimensional arrays, as illustrated in FIG. 5, enabling higher energy extraction or larger-area deployment. The modular units can range in size from 1 μm×1 μm to 100 cm×100 cm without loss of functionality. A unique advantage of this architecture is that the piezo-porous cavity can conform to the shape of the underlying transparent substrate, whether flat, concave, convex, or arbitrarily contoured allowing integration into non-planar optical systems

The tunable RCS device enables a broad range of advanced photonic applications. The following examples illustrate several of these use cases. This technology is particularly well-suited for ultrafast Q-switching in pulsed solid-state lasers, compact light sources for LiDAR systems, and reconfigurable mirrors used in beam-steering arrays for AR/VR displays. In quantum photonic architectures, the mirror can serve as a dynamically tunable spectral filter or cavity coupler, providing rapid control over single-photon sources or frequency-bin encoded qubits. For optical neural networks, the platform's potential modulation bandwidth exceeding 100 GHz allows real-time manipulation of photonic synapses. Other applications include fiber-based laser pulse amplification, coherent optical power routing, and remote ignition systems, where stored optical energy is released on demand with minimal latency. Additionally, the wide bandgap of III-nitride materials enables operation under high optical intensities and elevated temperature conditions.

This example describes the use of dynamically tunable RCS device based on nanoporous piezoelectric III-nitride materials for ultrafast laser energy modulation, storage, and controlled release. The architecture supports both integrated photonic systems and free-space laser configurations, with particular relevance to pulsed laser systems and energy delivery for high-impact applications such as laser-driven nuclear fusion.

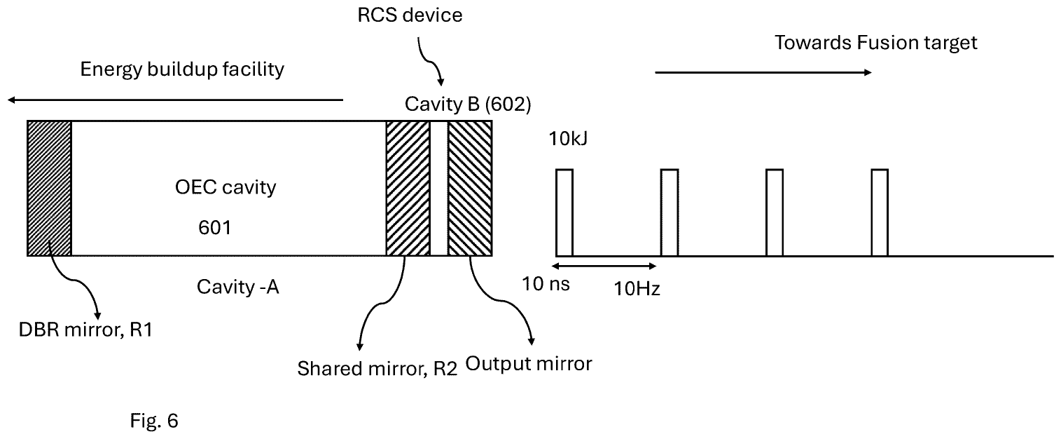

The system comprises of two optically coupled resonators, Cavity A and Cavity B, which is a cavity bounded between two DBRs of RCS device, that share a common intermediate mirror as shown in FIG. 6. Cavity A functions as the energy storage unit, bounded by two high-reflectivity distributed Bragg reflectors (DBRs), R1 and R2, both having reflectivity >99.999%. This configuration enables long photon lifetimes and substantial energy buildup through multiple round trips, with energy accumulation times ranging from nanoseconds to microseconds, depending on the pump characteristics and cavity dimensions.

RCS device is positioned adjacent to Cavity A and shares the intermediate mirror R2, named as shared mirror in FIG. 6. It is terminated on the opposite side by a moderately reflective mirror, named as output mirror, R3≈90%-99%, preferably 95%, and incorporates the nanoporous III-nitride piezoelectric layer as a central functional element. The active region comprises of piezoelectric material layer (e.g., GaN, AlN, or GaAlScN), which is first deposited and then converted into a porous structure through electrochemical etching. This porosity reduces the effective refractive index from around 2.5 (for example for GaN) to n_{zero} of around 2.1 with the active layer thickness of a N (2n_{zero}) and enables dynamic tuning via surface acoustic waves (SAWs) or applied electrical bias with the active layer thickness of a λ/(2nᵣ). Importantly, a small refractive index shift of Δn=n_{zero}-nᵣ≈0.005 is sufficient to bring Cavity B of RCS device into resonance with Cavity A, owing to the high finesse (narrow linewidth) of the cavities. n is the effective refractive index of the porous piezoelectric material layer. n_{zero} is the effective refractive index of the porous piezoelectric material layer without the electric field or the acoustic waves. nᵣ is the effective refractive index of the porous piezoelectric material layer with the electric field or the acoustic waves.

In the default state, Cavity B of RCS device is detuned from resonance, ensuring that optical energy remains confined within Cavity A. Upon activation, SAWs launched from IDTs or electric field-induced strain, the refractive index (n_{zero}) of the nanoporous piezoelectric layer in RCS device is altered, dynamically aligning its resonant mode with that of Cavity A and the refractive index (nᵣ). Once resonance is achieved, coherent energy transfer occurs across the shared mirror R2, effectively tunneling energy from Cavity A to Cavity B in a sub-nanosecond timescale (typically within 10-100 ps).

After energy transfer, laser light in Cavity B is rapidly emitted through the output mirror R3. The temporal profile of the emitted pulse can be shaped by controlling the acoustic or electric field waveform applied to the RCS device, which is called pulse shaping. This allows implementation of digital modulation schemes like on-off keying (OOK) or analog formats such as amplitude shift keying (ASK). Here we used cavity A to make the pulsed laser. Instead of cavity A, any kinds of pulsed laser is directly irradiated onto RCS device for the pulse shaping. In that case, depending on the wavelength, each thickness of DBR and cavity layer should be changed.

FIG. 6 illustrates a practical scenario in which Cavity A, 601 accumulates laser pulses over a period, e.g., 0.1 seconds, and releases them in precisely controlled bursts. When the RCS device, cavity B, 602, is tuned into resonance for 10 ns, a 10 ns optical pulse is emitted.

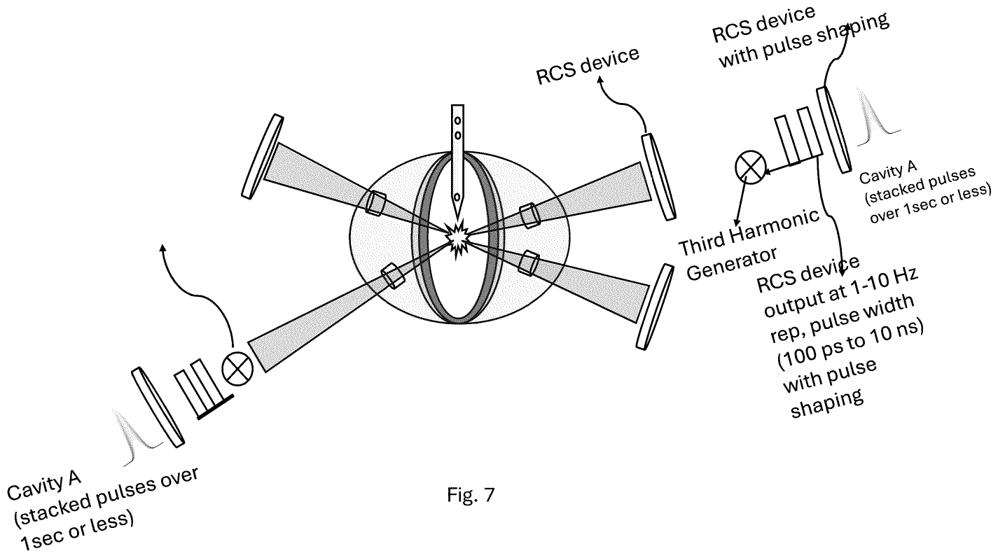

This modular unit can be replicated into a larger optical enhancement cavity (OEC) system where multiple output mirrors, each based on RCS device, serve to extract and route high-intensity pulses. As shown in FIG. 7, such an array can be configured to deliver pulses to laser fusion targets. In these applications, the energy released from RCS device can be passed through third-harmonic generators (THG) to convert the output to the UV range, which is suitable for inertial confinement fusion. The pulse-shaping capability of the RCS device allows for precise generation of nanosecond and picosecond pulses (e.g., 100 ps) for tailored compression and ignition. The additional RCS device also could be placed after the THG for the pulse shaping. In that case, another RCS device works only as a cavity dumper. For UV range, the porous piezoelectric material should be AlScGaN which has a band gap energy more than 3.5 eV (the wavelength is shorter than 350 nm) by adjusting the mole composition of Al, Sc and Ga.

Moreover, a RCS device can be placed near the target chamber to fine-tune the delivery pulse parameters just prior to ignition. To address the challenge of parametric instabilities, which often arise from monochromatic illumination, the invention allows for construction of multiple wavelength-specific OEC modules. Each OEC can be tailored to a different wavelength in the 1040-1080 nm range, with a corresponding RCS device designed for precise tuning and switching at that wavelength. Also, THG generates UV (around 350 nm) and green (around 530 nm) lasers from IR laser of around 1060 nm irradiation. Both of UV and green laser could be used to make the broad band laser to minimize the parametric instabilities.

Importantly, the wide bandgap of III-nitride materials ensures compatibility with both the fundamental and third-harmonic wavelengths, as these materials exhibit low optical absorption even in the UV range, making them ideal for THG integration.

While this example is highly compatible with photonic integrated circuits (PICs) made from III-nitride-on-silicon or silicon-on-insulator platforms, its utility extends beyond on-chip applications. The same principle can be scaled up for use in free-space laser amplifiers, energy modulation modules in LiDAR systems, adaptive optics for high-energy laser facilities, or pulsed ignition setups. The RCS device can be fabricated on fused silica, sapphire, Si, or SiC substrates for improved thermal and optical handling in large-format implementations. The RCS device could be deposited as a switching, pulse shaping, optical intensity control, optical filter or optical wavelength separation on any kinds of substrate such as silicone (Si) for the photonic integrated circuits (PICs). Additionally, the RCS device can be integrated within micro-opto-electro-mechanical systems (MOEMS) for packaging in aerospace and defense environments.

From a fabrication standpoint, the porous layer is etched from a pre-doped (such as Si-doped) III-nitride film using electrochemical methods and is capped with a dielectric or undoped GaN layer for surface stability. IDTs are patterned via standard lithography techniques and actuated with sub-10 mW RF signals. The performance metrics of this example include sub-100 ps switching time, modulation bandwidths exceeding 1 GHz, and minimal insertion losses (<1 dB). Furthermore, the use of wide bandgap materials ensures high optical damage thresholds and long-term reliability.

This example describes the application of a dynamically tunable RCS device to achieve intensity control in both near-eye immersive displays, such as augmented reality (AR) and virtual reality (VR, large direct emission displays and projection systems and in free-space visual systems. Precise control over the temporal and spectral characteristics of light is desirable for delivering high-contrast, color-stable, and responsive user experiences. The present invention overcomes the performance limitations of existing thermally or electro-optically modulated light sources by enabling sub-nanosecond modulation through a mechanically tunable porous III-nitride-based mirror called as RCS device

RCS device incorporates the tunable mirror: a λ/(2n_{zero})-thick porous piezoelectric material layer formed from materials such as GaN, AlN, AlGaN, or GaAlScN created by electrochemical porosification of a doped III-nitride film. The porosity, typically in the 10-60% range, results in an effective refractive index of n_{zero} between 1.9 and 2.1 where the volume of each pores is modulated by acoustic waves or electric field or external energy, and the refractive index is varied by approximately Δn=n_{zero}-nᵣ≈0.005. When LEDs used typically the FWHM of emission wavelengths are around 20-30 nm, that demands a more refractive index shift. RCS device structure and applied field strengths are optimized accordingly to accommodate required shift.

For acoustic waves, interdigital transducers (IDTs), patterned directly on or near the porous layer, launch surface acoustic waves (SAWs) that propagate through the porous material. These acoustic waves generate periodic tensile and compressive strain, deforming the pores and inducing transient pore-filling effects through fluid (in this invention fluid is air in the pore) displacement. As a result, the volume of each pore is modulated by the SAWs or bulk acoustic waves, and the effective refractive index is modulated. Another idea would be that these effects cause temporally localized refractive index changes and optical path length modulation within RCS device. For electric field, the high frequency electric field is applied through the electric contacts to the piezo electric material which has the pores.

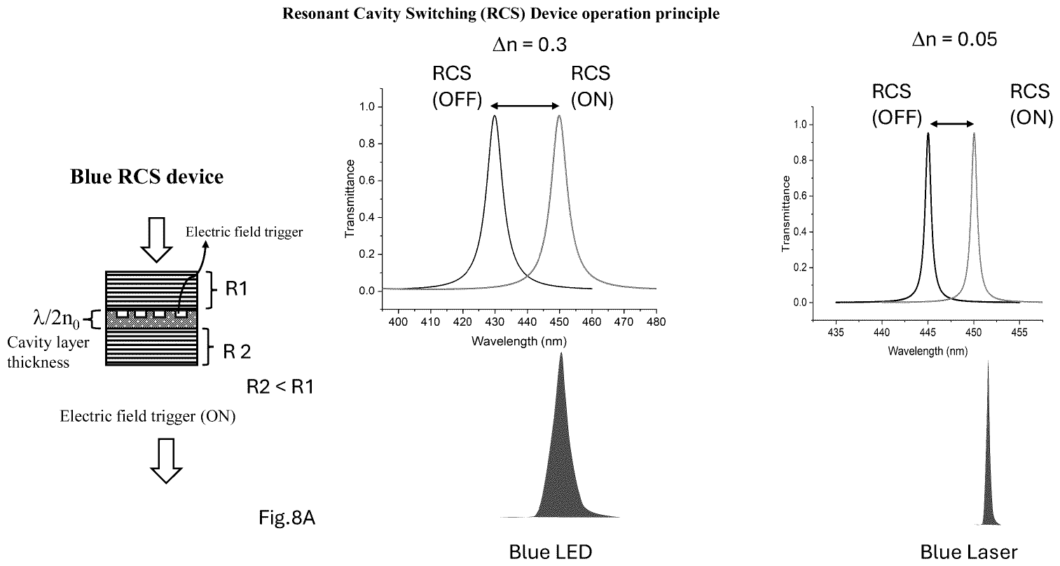

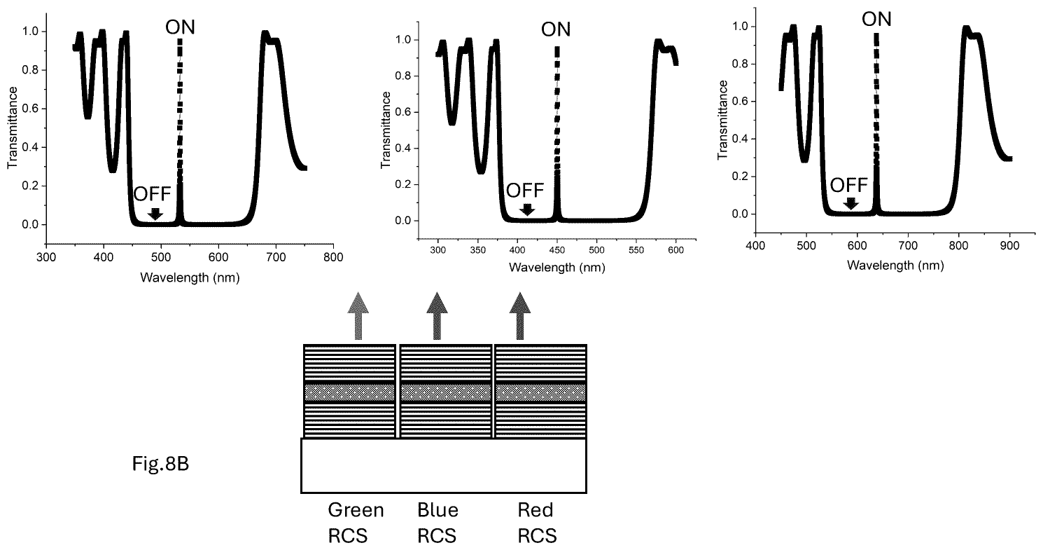

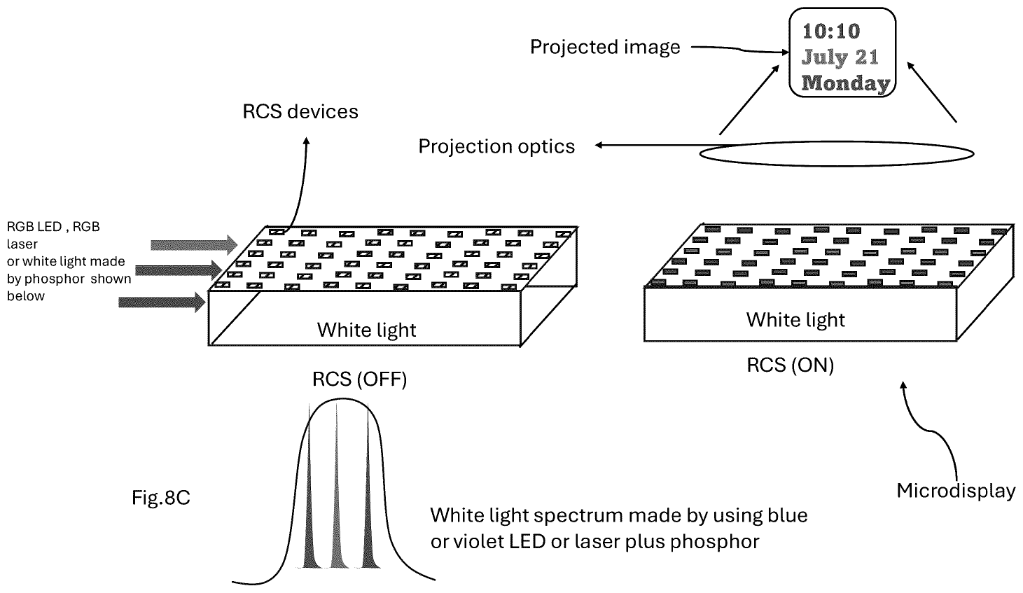

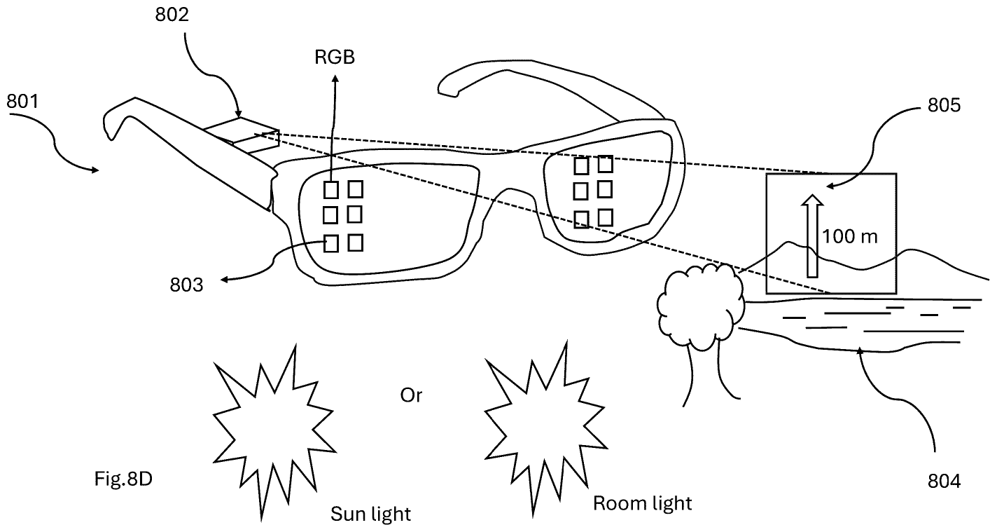

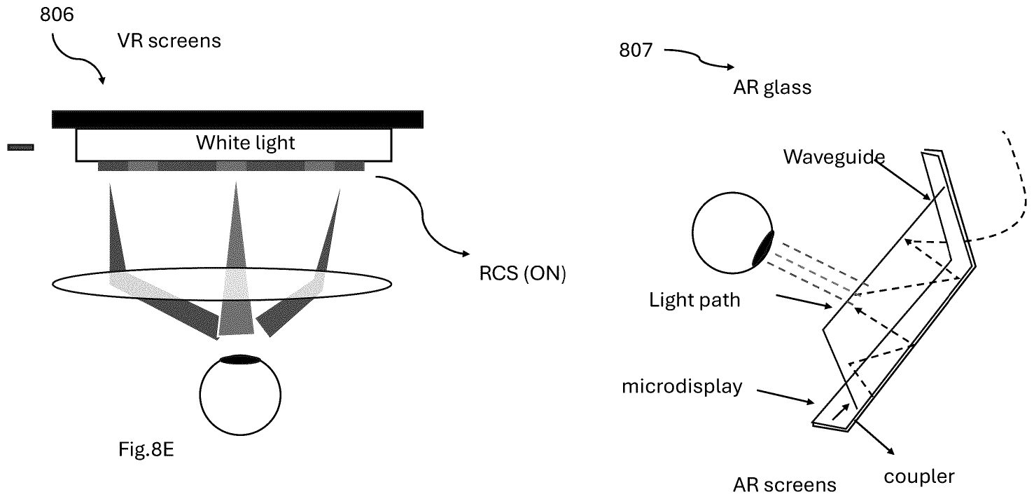

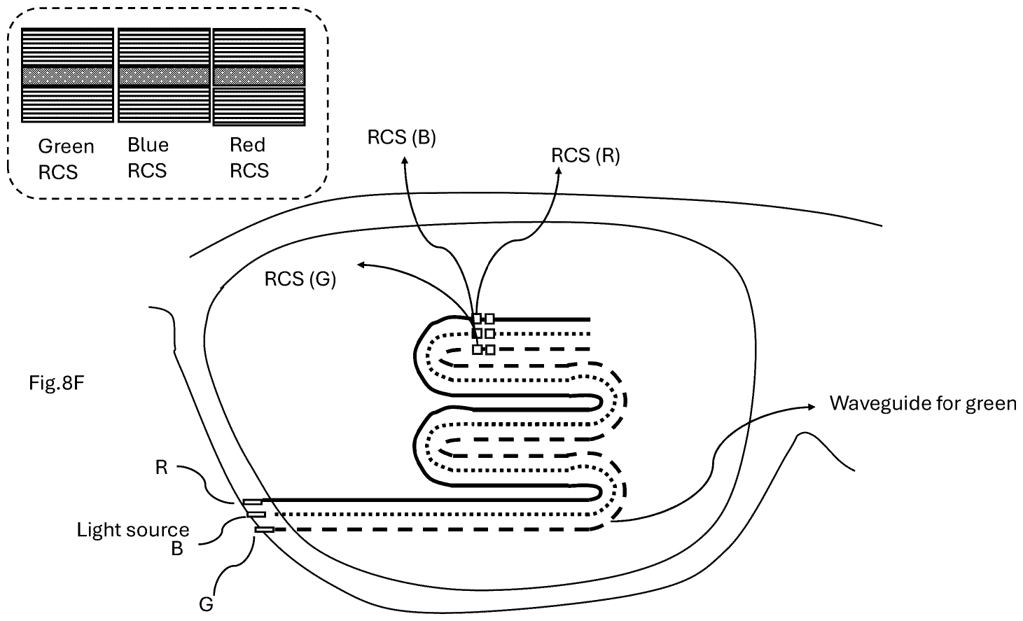

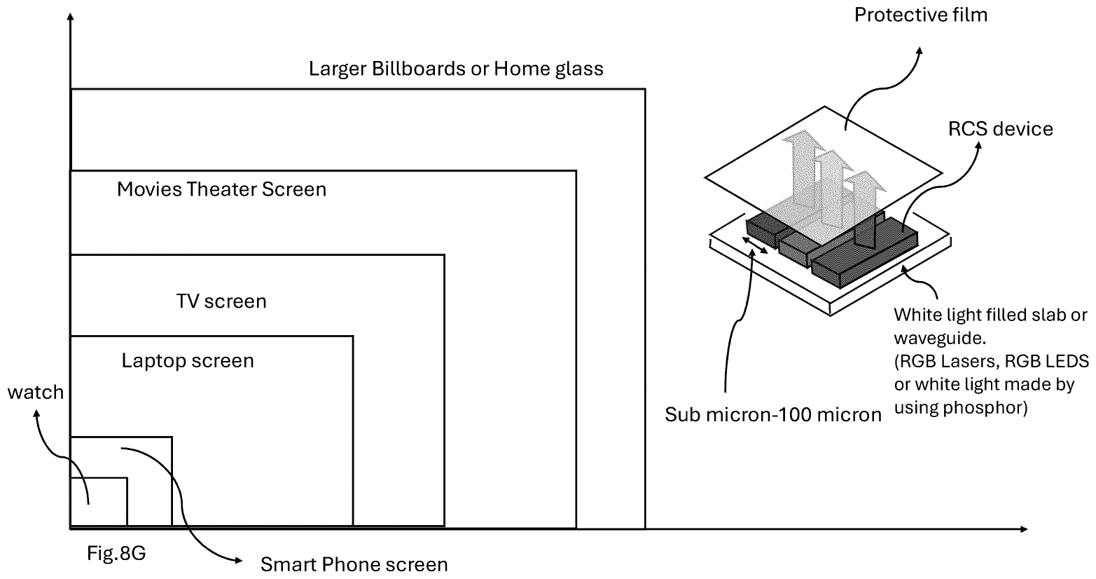

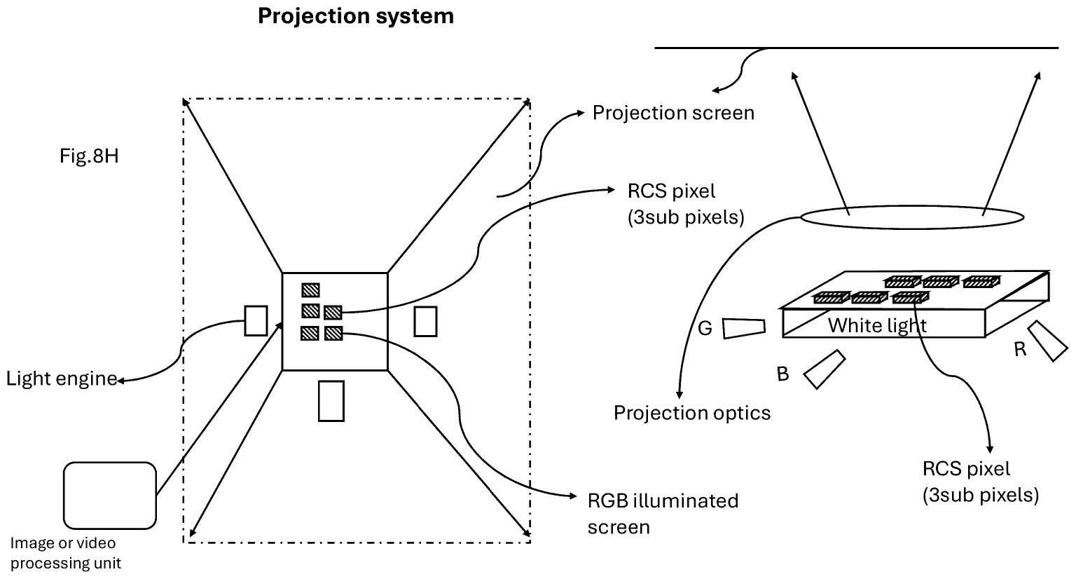

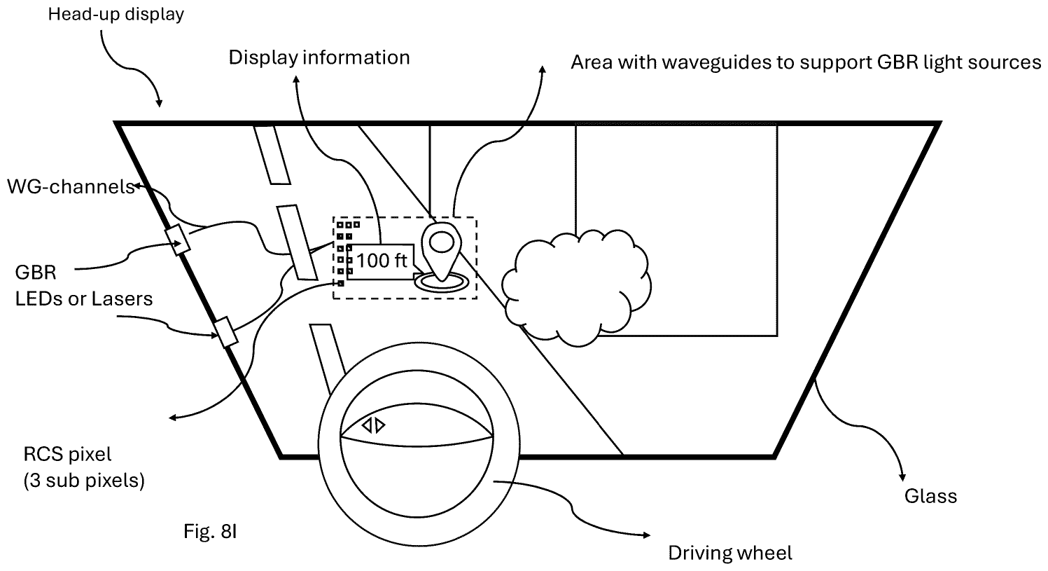

An example is the case of blue LED transmission through the RCS device, as illustrated in FIG. 8A. The figure shows two configurations: one with three pairs of DBRs and another with five pairs of DBRs on either side of the central porous layer. The resonant transmission peaks for both cases, with the electric field switched on and off, are also depicted. As seen, the full width at half maximum (FWHM) of the transmission peak is approximately 10 nm for the three-pair structure and narrower than 2 nm for the five-pair structure. When the electric field is applied, the modified refractive index of the porous layer alters the optical path length, shifting the transmission peak toward a center wavelength of 450 nm in both DBR configurations. For comparison, the figure also shows a typical blue LED emission centered at 450 nm and a laser source at the same wavelength. Alternatively, using more pairs are necessary for display applications when LEDs are used, in order to stop bleeding of light into the screen when RCS is off, however, by introducing local dimming zones into the display architecture, it is easier to get crispier images.

The spectrum width (FWHM) of each blue LED and blue laser diode (LD) has 20 nm and 1 nm, respectively. Thus, the wavelength shift of RCS device between detuning and tuning should be more than 20 nm for blue LED and more than 1 nm for blue LD to extract most of the emission energy of LED and LD, as shown in FIG. 8B. The wavelength shift of 20 nm is achieved by changing the effective refractive index Δn=0.3 using the AlScGaN porous cavity layer. The wavelength shift of 1 nm is achieved by changing the effective refractive index Δn=0.05 using the GaN porous cavity layer, as shown in FIG. 8A. The tuning transmission spectrum width of RCS device is only 10 nm. Thus, about 50% of each LED emission is extracted assuming each spectrum width is 20 nm. In that case of LD, the light extraction efficiency of RCS is 100% due to the narrow spectrum width of each laser.

In this configuration, a transparent slab with the RCS device deposited on its first surface can primarily block the transmission of the LED or laser spectrum when no electric field is applied. When the electric field is activated, the refractive index is modified, and the device becomes transmissive to the respective wavelength.

A continuation of this concept for full-color operation is shown in FIG. 8B, where RCS devices designed for blue, green, and red transparency are illustrated. The transmission characteristics can be tailored to achieve sharper bandwidths and higher resolution simply by adjusting the number of DBR pairs surrounding the porous layer. Present invention of FIGS. 8A and 8B uses red, green and blue (RGB) LED or LD to make the display because the high light extraction efficiency is expected for display as mentioned above. Also, white LEDs made by using blue or violet LED plus phosphor could be used to make the display. In this case, among the broad spectrum of white LED, only red, green, blue spectra with the spectrum width of 10 nm is extracted by RCS device. Thus, the efficiency becomes smaller.

Individual RGB channels at 450 nm (blue), 530 nm (green), and 635 nm (red) whether from LEDs, lasers, or other sources can be independently managed using RCS devices as intensity control elements. Each channel allows precise modulation of luminance, contrast, and color composition, enabling high-fidelity rendering in dynamic visual environments. The RCS device supports modulation of pulse duration, shaping, and amplitude.

FIG. 8C presents an application-oriented structure. Here, red, blue, green, or white-light sources (the latter generated by blue or violet LEDs combined with phosphor) are introduced into a transparent substrate. On one side of the substrate, where images or videos are intended to be viewed, RCS devices are patterned lithographically. Since these devices can be fabricated with pixel sizes ranging from submicron to macroscopic scales, they allow for extremely high-resolution displays. This approach eliminates the need for integrating multiple active RGB sources, which is particularly challenging when combining blue and green emitters based on InGaN alloys with red emitters based on either InGaN or AlInGaP materials. When the chip size smaller than 10˜100 microns, the efficiency of AlInGaP based red LED is dramatically reduced to less than 5%. The efficiency of InGaN based red LEDs is still as small as 5%. It is almost impossible to make a micro LED display due to a lack of red LED. In the present invention, AlInGaP based red LED with a large chip size of more than 100 microns could be used as a red light source. The subpixel size is determined by the RCS device size, not LED chip size.

The RCS device is thus well-suited for integration into AR/VR projection systems, display engines, spatial light modulators, and beam-steering modules. Control circuitry can drive the integrated IDTs in synchronization with video signals or scan control inputs, enabling real-time, pixel- or beamline-level modulation of pulse timing, shape, and intensity.

Application example in AR and VR Glasses (See FIG. 8D), RCS devices used as an optical intensity control of each RGB light for display application.

Each pixel of the display is composed of subpixels of red, green and blue (RGB) color emission with a small square shape of 1 micron to 1 mm. In the present invention, each subpixel is red, green and blue RCS devices. The resonance or tuning of red RCS device takes place with a spectrum width of red emission at the peak wavelength of 610 nm-640 nm. The resonance or tuning of green RCS device resonance or tuning takes place with a spectrum width of green emission at peak the wavelength of 510 nm-540 nm. The resonance or tuning of blue RCS device or tuning takes place with a spectrum width of blue emission at the peak wavelength of 440 nm-470 nm.

In the case of blue RCS device, the resonant or tuning takes place with the spectrum width of 20 nm at the peak wavelength of 450 nm under the applied acoustic wave or electric field or external energy. The resonant or tuning wavelength without the applied acoustic wave or electric field is around 430 nm or 470 nm because the spectrum width of blue is as broad as 20 nm. The resonant or tuning spectrum width of the RCS device is broadened by reducing the number of periods of the DBR to increase the light extraction efficiency of blue RCS device by covering the whole spectrum of blue LED emission. Other red and green RC-LEDs are same as the blue LED except for the wavelength and spectrum width. A laser diode has a narrow spectrum width which is easily within the resonant or tuning spectrum width of the RCS device. In the views of the efficiency of RCS device, the laser light source would be the best. Next would be the LED light source.

Conventionally, liquid crystal display (LCD) has been used with a poor wall plug efficiency (WPE) of 5% because LCD must use a polarized light and color filter as a switching device. Also, organic LED (OLED) display has been used with a poor WPG of 10%. The present invention of RCS display would have a high efficiency of more than 30% because WPE is determined mainly by the efficiency of LED and laser diodes (LDs). The current WPE of RGB LEDs and LDs have an efficiency of 30˜80%. The RCS device would have a high light extraction efficiency of more than 90%. Instead of micro-LED display, RCS device could be used with a high efficiency of up to 30% because the subpixel size is determined by a size of RCS device as mentioned above. The response time of LCD is order of milliseconds. The response time of OLED is from milliseconds to microseconds. The response time of RCS device is in the order of nanoseconds which means RCS device display pixels can switch between colors almost instantaneously, minimizing motion blur and ghosting, particularly in fast-paced games. Color rendering of the RCS should be the best by using the RGB LEDs and LDs as a light source.

An example implementation is illustrated in FIG. 8D, where an AR/VR eyewear device 801 incorporates the pixels where each pixel is composed three RGB subpixels of RCS devices. The RGB LED or laser light are brought to each pixel through the waveguide, and each pixel is formed on the waveguide to extract RGB color light through RCS device. All electronic controls, including camera inputs, signal drivers, and triggering circuits, are housed in a compact control module 802 mounted near the ear posts of the eyewear. The system enables real-time synchronization of display content 805 on a normal environment 804 background like sun light or room light without the need for complex active illumination systems.

Without the light sources, AR or a display on glass or any transparent materials are made by using pixel composed three RGB subpixels of RCS devices on AR glass or any transparent material. Outside lighting such as sunlight, room lighting and others become lights source to make the image on the AR glass or any transparent material. The cost should be much cheaper in this case because only electronic control system of RCS devices is required.

FIG. 8E displays AR and VR application gadgets. 806 is an VR application, where the display image is enclosed in a closed environment so that user will get an immersion experience, like Games, animation, skill training, and others could be benefited with these applications, next is AR see through glasses in 807 image can be projected onto eye glass were by sending RGB photons through embedded waveguide patterned of the glass

FIG. 8F illustrates a see-through glass AR device, where waveguides are patterned on the image-display portion of the glass. RGB color lasers or RGB LEDs are coupled into the waveguides from the side frame, and RCS devices are integrated along the waveguides to control the transmission of each respective color for the intended image or video. The RCS devices are selectively activated according to the displayed content, allowing the projected visuals to overlay seamlessly onto the user's view of the surrounding environment.

FIG. 8G illustrates a range of display types that can be easily fabricated using our RCS devices. Regardless of screen size, RCS devices can be integrated as individual pixels or full-color operation on displays ranging from HD, 2K, 3K, 4K, 8K to more resolutions. Since the RCS devices are lithographically defined, pixel dimensions from submicron to millimeter scale are feasible and highly scalable. In this configuration, shown in FIG. 8G, the display screen is first illuminated with white light, which can originate from LEDs, blue or violet-excited phosphors, or lasers. Local dimming zones can also be implemented to enhance user experience and improve energy efficiency. The lithographically defined pixels on the screen are selectively activated based on the video or image content, enabling precise control over color and brightness. This approach allows for the highest possible resolution across the largest and smallest screen formats. Example applications, including watch displays, smartphone screens, televisions, laptops, theater projection systems, and billboard displays, are shown in the figure, each employing RGB pixels formed with RCS devices.

FIG. 8H illustrates a projection system concept designed to serve as a replacement for conventional laser projectors and presentation projectors, leveraging the unique functionality of RCS devices. In this system, micro-displays are fabricated by integrating arrays of RGB-capable RCS devices onto a substrate uniformly illuminated with white light. The white light can be generated using RGB LEDs, blue or violet-excited phosphor sources, or RGB laser-based illumination, providing flexibility in brightness and spectral properties.

The substrate, populated with lithographically defined RCS pixels, functions as a dynamic image plane. Each pixel can be individually modulated in intensity, color, and timing to reproduce complex images or video content. Depending on the application, the substrate can be scaled down to micrometer-scale dimensions for near-eye AR systems, or scaled up to centimeter or meter-scale panels for larger projection applications.

The modulated image formed on the RCS-equipped substrate is projected through a telescopic optical assembly, which magnifies and directs the output to a distant surface, such as a wall, screen, or holographic medium. By using the RCS architecture, the projection system eliminates the need for conventional spatial light modulators (such as LCOS or DLP chips) or complex laser-scanning optics, while offering advantages in speed, contrast, and scalability. For examples, the conventional LCOS uses LCD display which efficiency only 5% caused by the requirements of color filter and polarized light. Using RCS devises, the efficiency would become much higher as mentioned above.

Such a system supports high-resolution formats (e.g., High Definition to 8K and beyond) by virtue of the submicron to millimeter scalability of the RCS pixels. Additionally, it can incorporate local dimming zones and dynamic contrast enhancement, improving efficiency and visual quality. This approach enables the construction of compact, low-power, and high-brightness projectors for applications ranging from AR/VR micro-displays to large-scale theater and presentation systems.

Similarly, as shown in FIG. 8I, waveguide or projection type display can also be used in automotive head up display (HUD) applications and infotainment screens in the automotive. One such example is given in the FIG. 81, where on the see through glass on the driver end projected the destination information and next maneuver information on the front shield.

In an example, additional applications beyond immersive AR/VR displays, the described intensity control technology is applicable to: free-space or fiber optical communication, enabling high-speed data transmission; and dynamic holography, supporting phase and amplitude control for real-time 3D image reconstruction.

The use of wide-bandgap III-nitride materials offers advantages including thermal stability, high optical damage thresholds, and low UV absorption, ensuring long-term reliability. The porous architecture further enhances thermal dissipation and reduces carrier-induced degradation, resulting in high energy efficiency through demand-driven optical release rather than constant leakage or recombination losses.

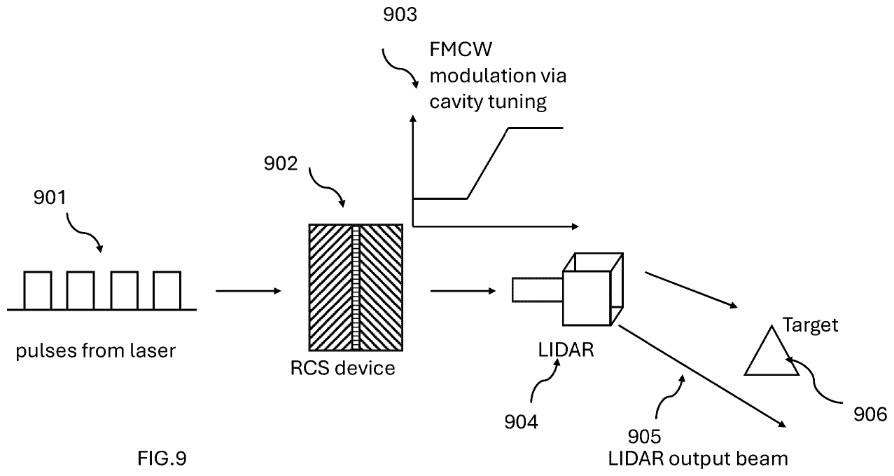

This example describes another application of a RCS device in high-performance LiDAR (Light Detection and Ranging) systems as shown in FIG. 9. LiDAR is desirable for autonomous navigation, drone-based surveying, robotics, and geospatial imaging applications where compact, high-power, and precisely timed optical pulses are needed. These pulses must be both spectrally and temporally sharp to resolve fine spatial features and measure distances with centimeter-level precision. Conventional solutions, such as gain-switched or externally modulated lasers, often fall short due to jitter, latency, limited pulse shaping flexibility, or integration complexity. This invention addresses these constraints by introducing a compact, all-resonant optical system capable of coherent, on-demand energy release through strain-activated resonance tuning. A laser with LiDAR wavelengths typically in the 850-1550 nm or 450-650 nm bands is irradiated into the RCS device for the pulse shaping. RCS device is formed between an input dielectric mirror (R1≥0.99) and on the other side of output mirror by a partially reflective dielectric mirror (R2˜ 0.95) for controlled energy output. At the core of RCS device lies a thin layer of nanoporous piezoelectric III-nitride semiconductor alloy such as GaN, AlN, AlGaN, or GaAlScN, among others. This porous layer, created through electrochemical etching of doped thin films, provides a highly tunable optical refractive index. Alternative a piezoelectric material with pores can be used.

To activate the tuning process, interdigital transducers (IDTs) are lithographically patterned adjacent to the nanoporous layer. These IDTs launch surface acoustic waves (SAWs) across the porous semiconductor, inducing directional mechanical strain. Because the nanopores possess random orientation and high surface-to-volume ratio, the SAW interacts strongly with the pore network, enhancing material displacement in preferential directions. This in turn leads to pore boundary deformation or partial pore filling, resulting in a change in refractive index, typically on the order of Δn˜0.005 to 0.5. Such an index shift is sufficient to bring RCS device into spectral resonance, whose linewidth typically lies in the 1 μm to several nm range.

Initially, RCS device is in off-resonance, and all incoming light energy is reflected. When a SAW pulse is applied, the resulting strain dynamically modulates the optical thickness of the porous layer in RCS device aligning its resonance with the wavelength of the incident laser.

These pulsed laser emissions can be shaped to have any durations with a response time of sub nanosecond of RCS device. The system is capable of operating in both single-shot and burst-mode configurations. Burst-mode operation is achieved by sequentially triggering surface acoustic wave (SAW) pulses, thereby releasing energy in programmable pulse trains.

This functionality is particularly advantageous in frequency-modulated continuous-wave (FMCW) LiDAR systems as shown in FIG. 9. The pulsed lasers dynamically shaped by bringing it into RCS devices, which includes a piezo-porous tunable cavity, 902. Through this resonance modulation approach rather than conventional direct laser frequency modulation the desired temporal and spectral pulse shape, 903 is achieved. The shaped pulses, whether single-shot or burst-mode, are then delivered to a LiDAR module, 904 which projects the beam, 905 onto a target 906. The integrated detection and analysis circuitry within the LiDAR device interprets the reflected signals, enabling precise characterization of the target's geometry and surface features based on the modulated pulse waveform.

This example describes the use of dynamically tunable RCS device functional mirrors to control light-matter interactions in quantum photonic platforms, particularly in the contexts of cavity quantum electrodynamics (cQED) and solid-state quantum optics. These applications require precise spectral and temporal alignment between a quantum emitter and a confined optical mode to enhance photon extraction efficiency, enable deterministic single-photon emission, and support high-fidelity quantum gates or entanglement protocols.

Conventional cQED systems rely on static, high-Q resonators engineered to match the emission wavelength of embedded quantum systems, such as quantum dots, color centers, or trapped ions. However, practical issues like inhomogeneous broadening, strain-induced spectral drift, and fabrication variability often result in spectral mismatch, weakening the emitter cavity coupling. Moreover, traditional tuning approaches, such as thermal shifting or mechanical actuation, are generally too slow, bulky, or incompatible with chip-scale integration.

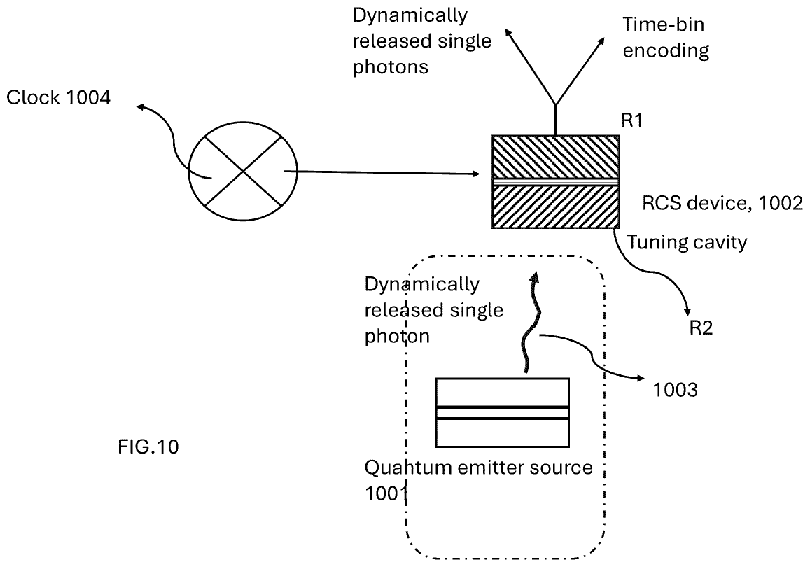

This invention addresses these challenges using a RCS device architecture that achieves real-time resonance tuning via dynamic refractive index modulation, with sub-nanosecond response time. As shown in FIG. 10, contains a quantum emitter, 1001, RCS device, 1002, functions as a dynamically tunable output cavity and enables controlled photon 1003 extraction.

The two systems are coupled via a high-reflectivity dielectric DBR (R2≥0.9999). All DBRs are fully dielectric to ensure minimal absorption and high reflectivity across visible and near-infrared wavelengths.

Quantum emitter, such as an InGaN quantum dot, a nitrogen-vacancy (NV) or silicon-vacancy (SiV/GeV) center in diamond, is embedded at an antinode of the optical field. The emitter can be integrated through site-controlled epitaxy, pick-and-place nanocrystal transfer, or other deterministic positioning techniques.

RCS device contains a λ/(2n)-thick nanoporous piezoelectric III-nitride layer (e.g., GaN, AlN, AlGaN, or GaAlScN), created by electrochemical etching of a doped semiconductor film. n is an effective refractive index of nanoporous cavity layer. The resulting porous structure comprises of vertically aligned nanopores (˜10-30 nm diameter), with porosity tuned to achieve an effective refractive index in the range, e.g., of 1.9 to 2.1.

Dynamic resonance tuning in the RCS device is enabled by surface acoustic waves (SAWs) or piezoelectrically induced strain. These are applied via interdigital transducers (IDTs) or electrodes patterned directly on the cavity surface. The acoustic waves deform the nanoporous matrix, inducing a refractive index shift through mechanical strain and partial pore filling. A change of Δn˜0.005 or more is typically sufficient to bring the RCS device into resonance with the emitter's optical transition, allowing coherent energy transfer from quantum emitter to RCS device output.

During idle operation, RCS device is spectrally detuned to confine spontaneous emission transmitting. Upon a heralding signal or synchronized clock trigger, 1004, a SAW pulse or electric field is applied to activate RCS. When its resonant mode aligns with the emitted photon from quantum emitter, energy coherently couples across DBR R2 and is emitted through the output mirror, R1. The photon is then directed into a waveguide or free-space optical channel for collection or further processing.

This dynamic release mechanism enables near-deterministic single-photon emission with improved temporal indistinguishability, which is critical for quantum networking and teleportation. It also enables time-bin encoding, where the temporal slot of the emitted photon defines its logical state for quantum computing. Furthermore, such timing control facilitates high-fidelity Bell-state measurements, as multiple quantum emitters can be tuned to interfere synchronously on demand.

The entire system is compatible with cryogenic operation. III-nitride semiconductors provide wide bandgaps and low phonon interaction rates, supporting quantum coherence at cryogenic temperatures. Dielectric DBRs made from materials such as SiO₂/Ta₂O₅ or HfO₂/SiO₂ offer high reflectivity and thermal stability across the 600-800 nm range. IDTs can be fabricated from transparent conductive oxides like ITO or thin patterned metal layers to minimize optical loss while supporting fast SAW generation with rise times below 5 ns.

From a timing perspective, the system is optimized to match emitter dynamics. For a cavity thickness of ˜250 nm and SAW velocities of ˜4000 m/s (typical for GaN or AlScN), modulation times under 100 ps are achievable. This is well-suited to radiative lifetimes on the order of hundreds of picoseconds to a few nanoseconds, allowing precise temporal shaping of photon wave packets and enhancing coupling efficiency in real time.

This example illustrates the use RCS device in the context of ultrafast optical signal processing, a domain critical to next-generation computing, photonic interconnects, and real-time data handling. As traditional electronics approach their speed and power efficiency limits, the transition toward optical logic and all-photonic systems demands elements capable of sub-nanosecond modulation, delay, and routing. Conventional electro-optic and thermo-optic modulators, while widely used, suffer from inherent limitations in response time, power consumption, and thermal management. The proposed RCS device architecture with a strain-tunable nanoporous III-nitride piezoelectric mirror addresses these challenges by enabling ultrafast, low-loss, and scalable signal processing in both on-chip and free-space implementations.

The core structure of the RCS is designed as a high-finesse resonator, bounded by R1 and R2, with one mirror possessing reflectivity ≥0.99 to and is terminated by an output coupling mirror R2, which has a reflectivity typically between 0.95 and 0.98. This asymmetry enables selective release of input optical pulse onto R2 upon resonance matching with RCS device.

A key innovation lies in the active layer embedded within the RCS device. This region comprises a λ/2n-thick nanoporous piezoelectric III-nitride alloy layer such as GaN, AlGaN, or GaAlScN formed via electrochemical etching of a doped epitaxial film. The resulting pore sizes, typically 10-30 nm, ensure low scattering at telecommunications and visible wavelengths. The porosity level, typically 10-60%, reduces the effective refractive index (n) to 1.9-2.1, down from ˜2.5 in dense GaN, and facilitates dynamic tuning via strain.

Surface acoustic waves (SAWs), launched using interdigital transducers (IDTs) patterned near or directly over the porous layer, serve as the actuation mechanism for modulation. The strain introduced by the propagating SAW locally compresses and stretches the porous matrix. This mechanical deformation, coupled with transient partial pore filling at the nano-scale where fluidic or vapor-phase refilling occurs under compressive strain causes a reversible change in the effective refractive index (Δn˜0.005 or more). This is sufficient to allow the input pulse that was incident on R2 of RCS device to the output through R1.

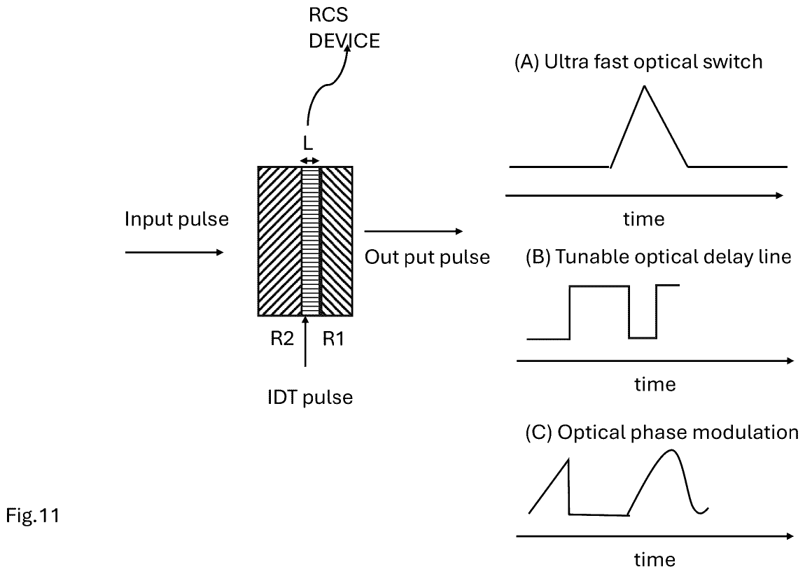

In signal processing applications shown in FIG. 11, an optical input pulse, either modulated or continuous wave is injected onto RCS device R2, where it is stopped due to the high reflectivity of the enclosing mirror. While RCS remains off-resonance. At a predefined timing event (e.g., synchronization with a data clock, logic trigger, or control signal), a SAW or voltage pulse is applied to RCS. The resultant effective refractive index shift aligns the resonance condition, facilitating coherent energy transfer across R2 and enabling the pulse to exit via R1. Because this switching mechanism is based on acoustic wave propagation rather than electronic carrier modulation or heat diffusion, switching times can be engineered to be below 100 ps, and are primarily governed by the acoustic velocity and cavity thickness. In FIG. 11, the RCS device is used as a pulse shaping, a pulse generator from CW, an optical delay, an optical phase modulation.

This dynamic coupling mechanism supports multiple modes of operation. In one configuration, the structure functions as an ultrafast optical switch releasing the stored pulse only upon actuation. In another, it acts as a tunable optical delay line: by varying the delay between input and actuation, the temporal position of the output pulse can be programmed with picosecond accuracy. Optical phase modulation is also achievable by applying controlled SAW amplitudes without initiating resonance transfer, inducing a shift in the accumulated optical phase according to:

$$Δ ϕ = 2 πΔ nL / λ$$

where L is the cavity length of the porous layer in RCS and λ is the operating wavelength. This capability forms the basis for optical interferometry, phase-encoded logic, or analog signal processing.

An important advantage of this architecture is its suitability for scalable optical logic and memory. Multiple dual-RSC units can be fabricated in series or parallel, with independent or synchronized IDTs enabling logic functions such as AND, OR, and XOR gates. For instance, in an all-optical AND configuration, two SAW pulses from separate IDTs must arrive simultaneously to bring RCS into resonance, allowing pulse extraction only when both conditions are met. This logic-level behavior can be extended to memory latches, optical flip-flops, and multiplexing units without the need for intermediate electronic circuitry.

Performance metrics from such devices are promising. Bandwidths exceeding 500 MHz, extinction ratios >20 dB, and insertion losses <1 dB have been demonstrated in related SAW-driven structures. The nanoporous layer further reduces mechanical impedance mismatch with surrounding layers, promoting efficient SAW confinement and low-voltage operation. Moreover, the absence of thermal tuning or carrier diffusion mechanisms results in excellent thermal stability, minimal jitter, and low latency.

Importantly, the described functional mirror system is not restricted to on-chip use. Due to its planar form factor and narrow angular divergence, it can be coupled to free-space optics or fiber systems when required. For example, it can be implemented as a beam-triggered modulator in a fiber-laser-based clock distribution system, or embedded in a photonic signal processor for remote sensing applications.

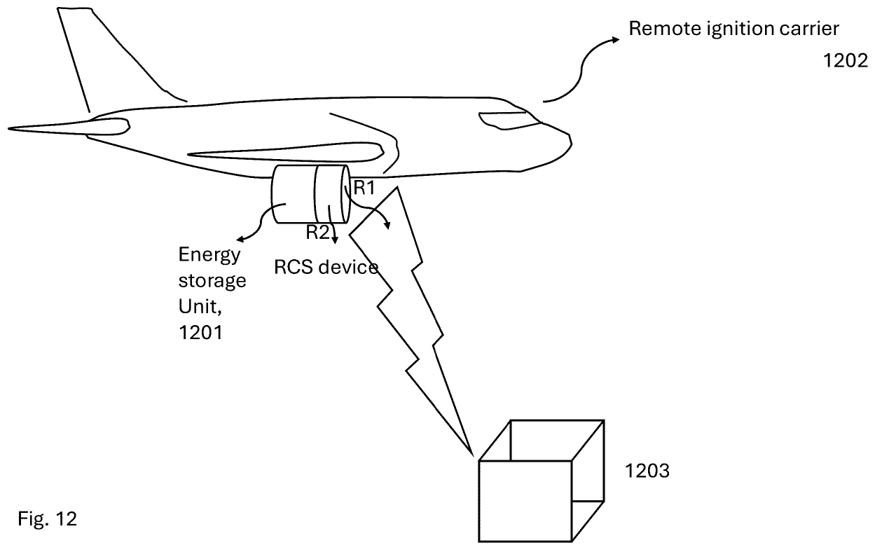

This example describes the application of the RCS device in contactless optical ignition and high-energy standoff energy delivery systems, suitable for use in aerospace propulsion like the example in FIG. 12, micro-thrusters, sealed environments, and advanced photonic systems requiring non-invasive yet precise energy deposition. The invention leverages ultrafast extraction of laser beam through the RCS device to deliver bursts of concentrated optical power on demand, remotely and without physical contact. The same mechanism can also be extended to systems where coherent high-fluence light pulses are directed toward distant or sensitive targets, enabling localized disruption or initiation of photochemical or thermal effects particularly useful in secure disabling mechanisms, countermeasure systems, or precise energetic interventions.

The functional architecture, integrated onto a energy carrier, 1202, comprises high energy pulses that need to be released at a designated area. Adjacent to high energy storage 1201, RCS device serves as the release channel, formed between the mirror (R2) and an output mirror (R1, R1<R2), and incorporates a nanoporous III-nitride piezoelectric layer that enables dynamic refractive index modulation.

This porous layer remains off-resonant with respect to the optical field inside storage under idle conditions, thereby preventing premature energy transfer. It is only upon receiving a remote actuation signal, either via electrical input or RF command, that surface acoustic waves (SAWs) or piezoelectric strain are activated via interdigital transducers (IDTs). These perturbations induce a controlled strain field across the nanoporous matrix, causing partial pore deformation and effective refractive index shifts (Δn˜0.005 or more), precisely enough to match the optical resonance condition of the stored energy with that of RCS device.

At this point of resonance, the two systems couple coherently, allowing near-complete energy transfer from the storage into the RCS device. The optical energy is rapidly emitted through the partially reflective mirror R1, forming a focused, high-fluence light pulse. Because the emission is triggered purely by mechanical strain rather than slow carrier dynamics or thermal drift, sub-nanosecond response times are achievable, with timing precision dictated by the SAW propagation delay typically <300 ps for cavity lengths in the hundreds of nanometers and acoustic velocities in the 3600-5800 m/s range.

This optical pulse can then be focused onto ignition targets 1203, such as reactive surfaces, gaseous mixtures, or micro-scale solid fuels, initiating combustion or decomposition without any physical contact. Alternatively, by controlling the beam path and pulse fluence, the same mechanism can be used to deposit energy into distant or remote materials, enabling disruption, heating, or photo-triggering of chemical processes, especially in environments where electronic actuation is impractical or undesired. This includes disabling of subsystems, detonation of reactive materials, or energy dumping in adversarial or inaccessible settings, without explicitly invoking any weapons-related terminology.

The system can be integrated into aerospace ignition modules such as the one shown in FIG. 12, including micro-thrusters and hybrid engine initiators, where optical triggering provides ignition sequencing at arbitrary positions without physical wiring. In sealed or hazardous environments, such as high-pressure vessels or explosive material storage, this contactless approach ensures personnel safety and prevents stray discharges. Moreover, in optical disruption platforms or photonic countermeasure systems, the same mechanism may be used to deliver targeted optical energy to induce failure modes, disrupt vision sensors, or initiate energy transfer remotely.

Timing control is exact, driven by the delay between energy injection and actuation of resonance. This enables deterministic control over when the energy is released, with high synchronization accuracy to external systems or signals. Because the actuation is acoustic and mechanical in nature, electromagnetic interference is minimized, and the system remains robust under extreme electromagnetic or radiation conditions.

This example advances the utility of the RCS device units by enabling scalable, independently addressable, and spatially distributed energy extraction tailored for laser array systems. The proposed configuration integrates an array of tunable nanoporous piezoelectric output RCS devices, each designed for localized activation and coherent routing of the incident optical energy. This approach supports the rapid, programmable release of high-intensity optical pulses across multiple spatial channels, making it highly suitable for applications including optical phased arrays, reconfigurable LiDAR transmitters, distributed laser machining, and high-energy beam projection systems requiring coordinated multi-beam operation.

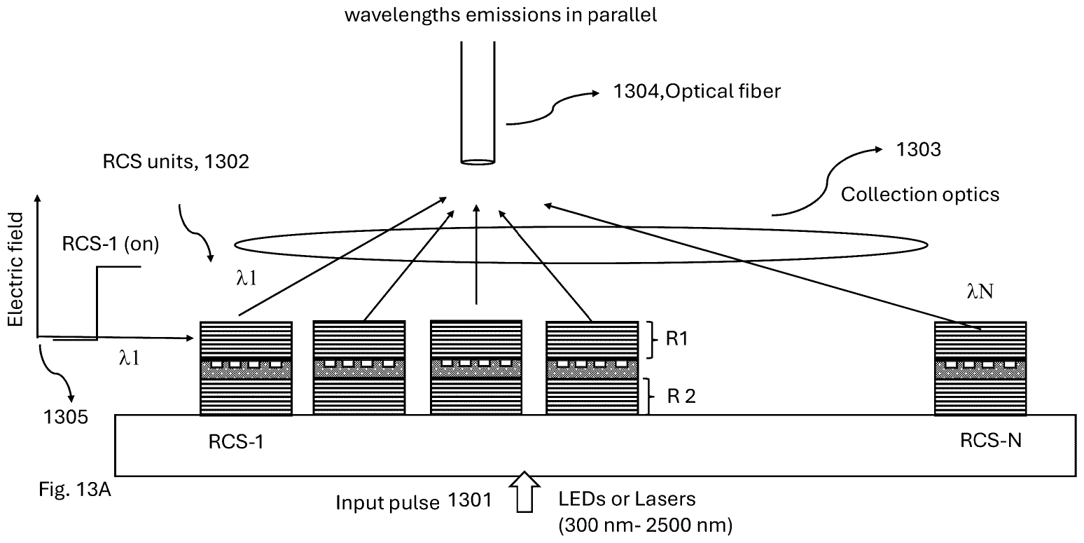

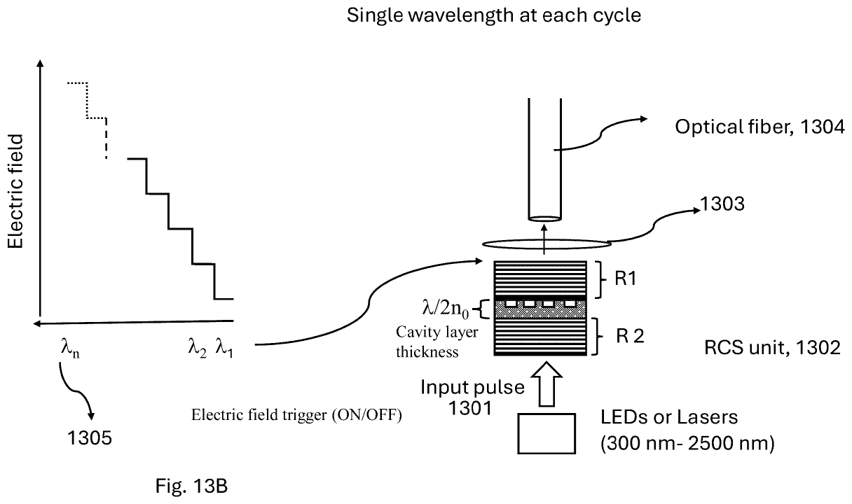

As illustrated in FIG. 13A, the architecture is built around a several RCS device units. A master energy storage, 1301, acts as the centralized energy supplier, can be a multi wavelength source. Energy such as laser, LED light or any light source of this region could be a pump source, either continuous-wave or pulsed delivered through optical waveguides, fiber injectors, or free-space couplers. Owing to its high finesse and extended photon lifetime, On the opposing side a spatially distributed set of output resonators, referred to as RCS units, 1302 is formed. Each unit comprises of a half-wavelength (λ/2n) thick nanoporous piezoelectric III-nitride layer (e.g., GaN, AlN, or GaAlScN), sandwiched between R2 and a partially reflective dielectric output mirror (R1, R1<R2). The nanoporous layers are precisely engineered to achieve effective refractive indice (n) in the range of 1.9-2.1, (this is an example when GaN is used, effective refractive index control 1 to <2.5 is possible) depending on the operating wavelength (λ₁, λ₂, . . . , λₙ), and are dynamically tunable via surface acoustic waves (SAWs) or direct voltage application through patterned interdigital transducers (IDTs). In this configuration, the applied RF or electric field is set for each RSC unit individually at a predefined value.

This porous structure not only provides favorable index contrast with the dielectric DBRs but also supports strain-mediated optical tuning. When actuated by a SAW or voltage signal, the piezoelectric cavity undergoes localized strain, resulting in transient pore deformation and partial pore filling. This mechanical-electrochemical interaction yields a dynamic increase in the effective refractive index, altering the optical path length. Then, a RCS device tunes with a wavelength that match the resonant condition. Similarly, the case with other RSC units, thus provides a spectrum of a single mode wavelengths from a multimode spectrum.

The RCS units can be organized in one-dimensional (1D) or two-dimensional (2D) arrays, with each unit independently controlled by its dedicated IDT or electrode pair. This enables both time-division multiplexing (TDM) and parallel (spatial) addressing of output units. Depending on system design, lateral spacing between neighboring RCS units can range from tens of microns to several millimeters, making the structure compatible with microlens arrays, diffractive beam shapers, or collimation optics, 1303.

The output section, labeled as application port, 1304, supports a range of spatial and temporal control schemes. In one scenario, adjacent RCS units are selectively activated with phase-shifted signals, allowing constructive interference and formation of directional output beams via coherent beam steering. In another, multiple RCS units are simultaneously actuated to produce a composite high-power beam with increased spatial footprint. These capabilities, combined with sub-nanosecond switching speeds, enable fast beam scanning, dynamic power redistribution, and even defensive or adaptive applications involving rapidly changing targets or beam pathways.

After each single mode laser is modulated for the signal, the modulated single mode laser enters into a multi-mode fiber, 1304, and multi-frequencies data transfer becomes possible using a single fiber. When receiving the signal, the same RCS is used to filter each wavelength which is mentioned later in details.

Another configuration is shown in FIG. 13B, where a single RCS unit (1302) is used to dynamically generate multiple discrete wavelengths from a multimode laser source. When the multimode input laser (1301) is directed onto the RCS device, the applied electric field (1305) is continuously tuned so that, for each satisfied resonant condition, a single longitudinal mode is isolated and transmitted. Each selected mode is coupled through collection optics (1303) into an application port (1304), such as an optical fiber, providing a sequence of spectrally pure outputs derived from the multimode input.

This technique demonstrates a novel method for tuning laser wavelengths. Traditionally, wavelength tuning has been achieved by varying the laser device temperature; however, this approach offers only a very limited tuning range. By using an RCS device, the tuning range becomes significantly broader due to a large refractive index change (Δn≈0.5), which can induce a wavelength shift of approximately 50 nm.

Additional integration is possible: on-chip photodetectors or embedded waveguides may monitor cavity resonance or output intensity; feedback electronics can optimize energy transfer timing; and fiber-coupled interfaces can route optical signals for use in aerospace modules, industrial manufacturing platforms, or advanced sensor systems.

This example introduces two scalable implementations of the dynamically tunable RCS device: (1) integration at the facet of an optical fiber either solid-core or hollow-core and (2) implementation as a suspended membrane on a planar substrate. Both configurations leverage a nanoporous III-nitride piezoelectric layer, sandwiched between distributed Bragg reflectors (DBRs), to facilitate ultrafast refractive index modulation and coherent control of optical energy.

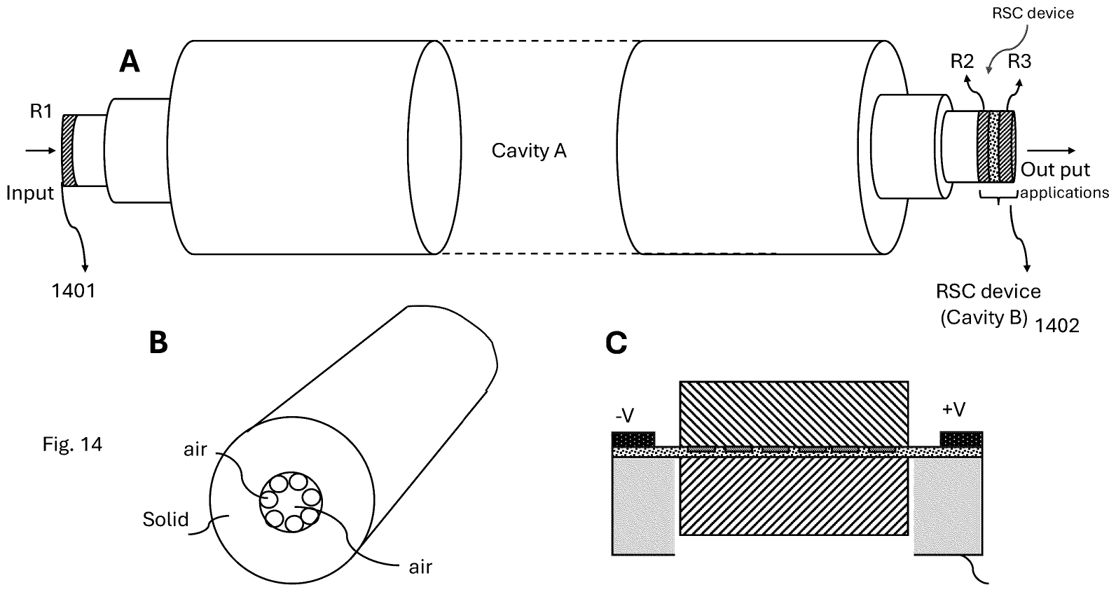

In an example, Fiber-Integrated Mirror Configuration are shown. (See FIGS. 14A, 14B)

In the fiber-integrated design, a Fabry-Perot cavity of OEC is formed between two precision-coated fiber facets. The rear facet, 1401 is coated with a highly reflective dielectric DBR (R₁≥0.99999), enabling high-finesse photon storage. The front facet hosts the tunable mirror stack as RCS device, 1402, comprising a nanoporous III-nitride semiconductor (e.g., GaN, AlN, ZnO, AlGaScN) with optical thickness λ/2n, enclosed between a shared high-reflectivity DBR and a partially transmissive output DBR (R3˜ 0.95-0.99). where n is refractive index of cavity layer in the RCS device.

In an example, the present architecture is compatible with both solid-core and hollow-core fibers: Solid-core fibers offer high mode confinement, particularly suitable for broadband applications and low-cost integration; and Hollow-core fibers minimize nonlinear effects and dispersion, allowing higher peak powers and preserving beam quality during buildup and extraction.

Refractive index tuning of the RCS is achieved through surface acoustic waves (SAWs) or piezoelectric actuation via interdigital transducers (IDTs). When off-resonant, photons remain confined. Upon actuation, the resonance condition is matched, enabling coherent tunneling of energy through the output DBR.

In an example, applications when one end of the fiber is formed as RCS device and in the other end of the fiber is injected with laser include: Ultrafast Pulse Carving and Cavity Dumping: Enables sub-nanosecond energy extraction from CW or Q-switched lasers, useful in supercontinuum generation, pump-probe studies, and programmable ultrafast sources; All-Optical Switching in Fiber Networks: Functions as a low-loss, GHz-rate switch, ideal for ROADMs and high-speed optical routing; Quantum Photon Control: With embedded quantum emitters (e.g., NV centers, QDs), enables deterministic single-photon emission aligned to quantum protocols; and Localized Optical Ignition: Focuses intense pulses to initiate combustion or plasma in sealed or remote environments, useful in aerospace propulsion or hazardous-area ignition.

In an example, membrane-Based Mirror Configuration is shown. (See FIG. 14C)

In this approach, the resonant mirror of RCS is fabricated as a suspended membrane across an etched window in a planar substrate (e.g., Si, sapphire, SiC). The cavity structure comprises of a nanoporous piezoelectric λ/2n-thick layer between two DBRs. The suspended geometry enhances acoustic confinement and facilitates rapid refractive index modulation with minimal damping.

Surrounding the mirror region are IDTs or electrodes for high-speed actuation. The architecture supports GHz modulation and nanosecond-scale phase or amplitude control. Its planar format makes it ideal for integration in chip-scale photonics and free-space optics.

In an example, applications include AR/VR Display Modulation: Acts as a GHz-speed spatial light modulator (SLM) for RGB laser control in wearable displays; Chip-Scale LiDAR Pulse Control: Serves as a fast Q-switch or pulse shaper for VCSELs and waveguide-based emitters; Photonic Neural Computing: Modulates amplitude and phase for optical weight encoding in AI accelerators; and Dynamic Beam Steering: Arrays of these mirrors can form reconfigurable meta surfaces or optical phased arrays, enabling high-speed holography, light-field projection, and beam deflection.

This example discloses a RCS device based optical switching device configured to dynamically divide a broadband optical source, such as a supercontinuum laser or a high-brightness light-emitting diode (LED) spanning the ultraviolet (UV), visible (VIS), near-infrared (NIR), and far-infrared (FIR) spectral ranges, into tens to several hundreds of narrowband, discrete wavelength channels. The device employs field-induced refractive index modulation within a nanoporous piezoelectric III-nitride semiconductor cavity of RCS device to rapidly reconfigure its spectral output. This capability enables ultrafast wavelength-division multiplexed (WDM) transmission directly into optical fibers, free space or wireless, supporting both short-haul and long-haul data communication networks, including those used in artificial intelligence (AI) data centers and distributed computing environments.

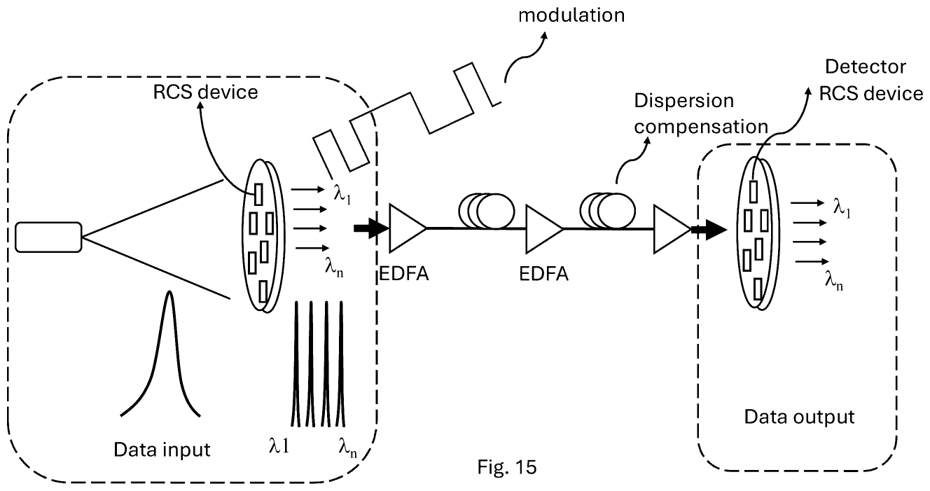

The switching architecture, illustrated in FIG. 15, is based on RCS. At its center is a nanoporous piezoelectric cavity layer composed of GaN, AlN, or AlScGaN alloys, engineered to achieve a tunable refractive index relative to its non-porous counterpart. The cavity layer, with a thickness ranging from 1 nm to 500 nm, supports resonance across wavelengths extending from ˜300 nm in the UV to beyond 2 μm in the FIR. Its porosity allows controlled pore-filling effects under applied electric fields, resulting in refractive index shifts from 0.005 to 0.5. These changes are sufficient to shift cavity resonance by 0.1 nm to 50 nm per applied field increment, enabling broadband and precise spectral control.

The cavity is flanked by asymmetric distributed Bragg reflectors (DBRs). On one side, a high-reflectivity DBR (R≥0.99) is constructed from alternating dielectric or III-nitride layers, such as SiO₂/Ta₂O₅, optimized for broadband reflection. On the opposite side, a partially transmissive DBR (R=0.20-0.99) enables controlled spectral leakage into the output channel. These DBRs collectively provide a stopband extending from 300 nm to ˜3 μm, allowing the device to accommodate the entire emission spectrum of a supercontinuum source or broadband LED. Electrodes and interdigital transducers (IDTs) are integrated atop or alongside the nanoporous cavity layer to generate surface acoustic waves (SAWs) in the 1-20 GHz range. These SAWs induce localized electric fields and mechanical strain, enabling sub-nanosecond refractive index modulation within the cavity.

The broadband input, spanning 300 nm to 3,000 nm, is dynamically filtered by the resonant cavity. By modulating the nanoporous layer's refractive index, the cavity can selectively resonate and transmit narrowband spectral slices with bandwidths as low as ˜0.0001 nm. Each device can generate between 2 and 500 independent wavelength channels, with dynamically adjustable channel spacing, such as 25 GHz to 100 GHz (corresponding to ˜0.2 nm to 0.8 nm near 1550 nm). The device functions both as a spectral slicer and as a switching multiplexer, supporting real-time wavelength selection and reconfiguration. Piezoelectric and SAW-driven control allows modulation rates exceeding 1 GHz, with switching speeds ranging from sub-nanosecond to a few nanoseconds, making the device compatible with next-generation WDM networks.

Following spectral slicing, each channel wavelength is modulated with carrier data using external or integrated modulators (such as Mach-Zehnder or electro-absorption modulators) before being transmitted through single-mode or multimode optical fibers. These channels can traverse either short-haul (intra-data center) or long-haul (inter-city or continental) distances. Upon reaching the receiving end, the channels are separated using conventional wavelength demultiplexers (such as arrayed waveguide gratings, thin-film filters, or the same class of tunable resonant-cavity devices). During demultiplexing and detection, the same class of resonant-cavity switching (RCS) devices can be deployed to dynamically gate each channel onto photodiodes, thereby enhancing the signal-to-noise ratio (SNR) by temporally filtering the incoming optical data. By acting as an optical gate or pre-amplification interface, the RCS device improves the effective sensitivity of photodiodes, especially when decoding weak signals after long-haul transmission.

These multiplexed and demultiplexed channels can be used individually or aggregated to achieve multi-terabit-per-second throughput across AI and cloud interconnect networks. Applications include high-channel-count WDM light sources for AI clusters, spectrally parallel optical matrix multipliers for neuromorphic processing, and dynamically reconfigurable optical switching fabrics for scalable photonic networks.

The RCS device operates uncooled at temperatures typical of computational hardware (60-80° C.), owing to the thermal stability of III-nitride semiconductors. It replaces bulky optical components, eliminating fixed filters and slow thermal-tuning mechanisms in favor of rapid, electric-field-driven control. The device processes ultra-broadband spectra within a compact, photonic integrated circuit (PIC)-compatible footprint. Furthermore, the architecture scales seamlessly with PIC systems by supporting integrated gain and dense wavelength routing, while enabling additional functionality, such as data modulation, wavelength MUX/DEMUX, and photodiode sensitivity enhancement, using the same RCS principles at both the transmitter and receiver ends.

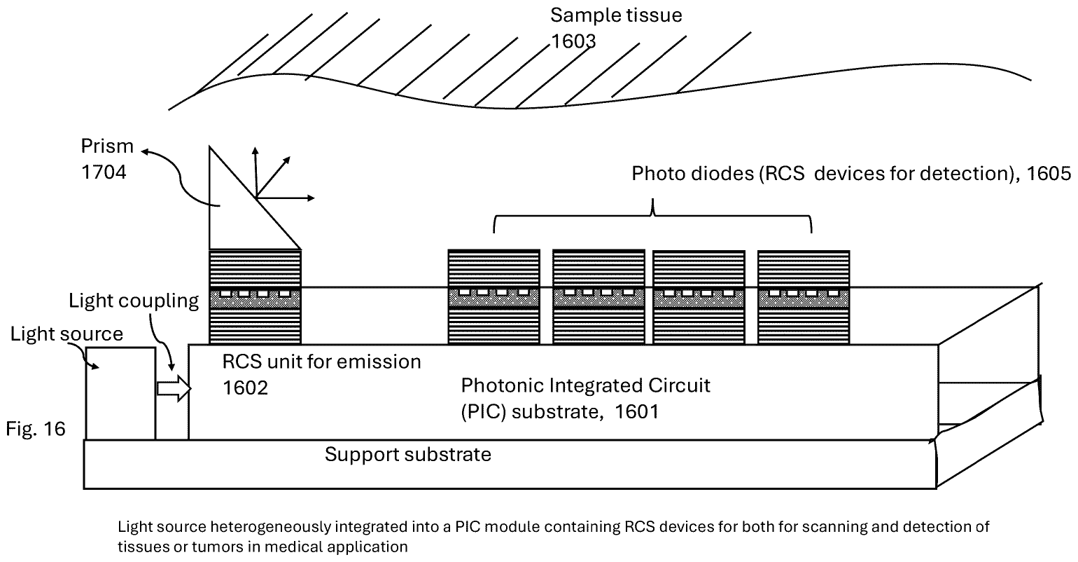

This example FIG. 16 discloses a dynamically tunable optical system utilizing RCS devices for medical diagnostics and therapeutic procedures. The system integrates RCS-enabled emitters, modulators, and RCS-enhanced photodiodes to provide wavelength-agile, temporally precise, and spectrally filtered optical functionality. These capabilities enable real-time tissue imaging, lidar-like mapping, and selective ablation or destruction of biological tissues, combining diagnostic and therapeutic functions within a unified photonic platform.

The optical source comprises of either a semiconductor laser diode, a Fabry Perot (FP) laser equipped with an RCS-based DBR facet, or a broadband LED converted into a tunable, coherent source using the dual-RCS amplifier configuration as described in other examples. In all implementations, the RCS element incorporates a nanoporous, piezoelectric cavity layer composed of GaN, AlN, or AlScGaN. By applying electric fields or driving surface acoustic waves (SAWs), the refractive index of the nanoporous cavity can be dynamically tuned, shifting its resonant dip by 0.1-50 nm. This tunability enables rapid wavelength scanning across biologically relevant spectral windows, such as 400-1,300 nm for diagnostic reflectance and fluorescence imaging, and 1,300-2,500 nm for deeper penetration or therapeutic tissue heating.

The RCS device also functions as an ultrafast optical chopper and shutter, capable of sub-nanosecond modulation without mechanical or slow electro-optic components. For diagnostic applications, the system operates in a lidar-like mode, transmitting precisely timed, wavelength-tunable pulses toward biological tissue. shown in FIG. 16, a light source is coupled to a photonic integrated circuit containing several functional devices for data analysis. Δn RCS unit 1602 generates or slices specific wavelengths from a broadband light source and directs them toward a tissue sample 1603 using a prism 1604. The backscattered or reflected signals are then detected by RCS-integrated photodiodes 1605, which incorporate the same nanoporous cavity and DBR configuration directly atop the photodiode structure. These RCS-enhanced photodiodes function as dynamic spectral and temporal gates, synchronizing detection with the emitted pulses while selectively transmitting only the target wavelength band. This architecture improves photodiode sensitivity by factors of 2-10 by suppressing background light, out-of-band scattering, and detector dark noise, enabling accurate depth-resolved imaging and tissue composition mapping.

For therapeutic applications, the system can deliver controlled doses of optical energy to specific depths or chromophores within tissue. By tuning the emission wavelength to match absorption peaks of key biological targets, such as hemoglobin, melanin, or water, and by shaping the pulse intensity and duration, the system can coagulate, ablate, or destroy targeted tissue volumes while minimizing collateral thermal or mechanical damage. The ultrafast modulation provided by the RCS devices allows precise energy deposition on microsecond to picosecond timescales, suitable for microsurgical operations, photothermal therapy, and localized tumor treatment.

The integration of RCS devices as emitters, modulators, and photodiode gates eliminates the need for external shutters, static optical filters, or mechanically tuned elements. The system achieves full wavelength agility, rapid pulse shaping, and synchronous detection within a compact, photonic integrated circuit (PIC)-compatible architecture. This allows the design of handheld diagnostic probes, endoscopic imaging and therapy tools, or large-scale clinical systems that unify high-resolution imaging and controlled tissue interaction in a single, scalable platform.

This example discloses a compact free-space optical (FSO) communication system for satellite-to-satellite and satellite-to-ground links, employing a single resonant-cavity switching (RCS) device to perform multiple roles: (1) isolating a single spatial and spectral mode from a high-power multimode source, (2) acting as a dynamically tunable output coupler and phase stabilizer, (3) modulating and shaping data pulses, and (4) serving as the wavelength-agile interface for free-space transmission. (5) multi-wavelength transmission for several data channels. By integrating these functions into one element, the system enables lightweight, power-efficient optical terminals capable of delivering multi-gigabit to terabit-per-second throughput over orbital distances.

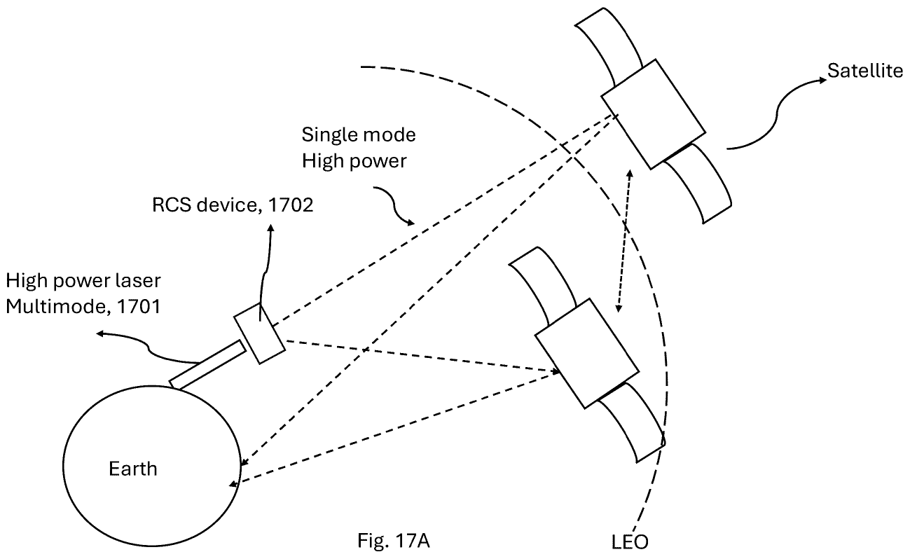

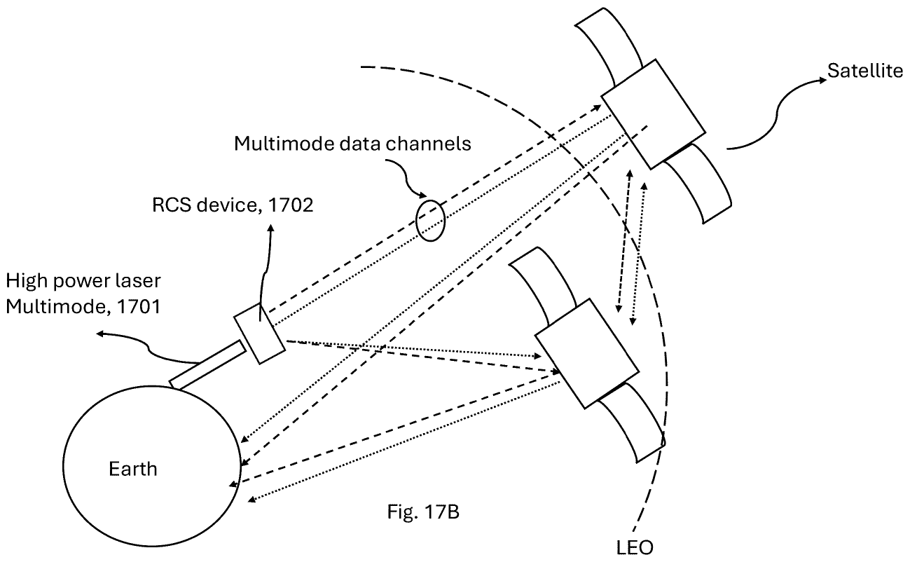

We propose two applications one depicted in FIG. 17A, where a high power single mode channel for long distance free space communication and in FIG. 17B for a multichannel data channel for larger bandwidth. The system begins with a high-power multimode optical source 1701, such as a fiber laser amplifier or a broad-area semiconductor laser, producing tens to hundreds of watts of optical power but with multiple longitudinal and transverse modes. The output from this source is directed toward the RCS device 1702, which incorporates a nanoporous, piezoelectric cavity layer (GaN, AlN, or AlScGaN) bounded by high-reflectivity distributed Bragg reflectors (DBRs). Through electric field or surface acoustic wave (SAW) modulation, the RCS dynamically tunes its refractive index, shifting its resonant dip by 0.1-50 nm and imposing a narrow spectral passband of 0.1-0.5 nm. This process filters out unwanted longitudinal modes and, by leveraging the cavity phase control, suppresses higher-order transverse modes, yielding a diffraction-limited, single-mode output beam suitable for free-space propagation.

Because the RCS can rapidly sweep its resonance, the same single element enables wavelength agility for frequency-hopping or wavelength-division multiplexing (WDM), allocating multiple channels across communication bands is possible as shown in FIG. 17B (e.g., the 1,530-1,565 nm C-band). Or a single multimode source can therefore feed multiple time- or wavelength-multiplexed transmission channels without additional filtering hardware as in FIG. 17A.

On the receiver side, a matching RCS-integrated photodiode can be used, but even without it, the transmitting RCS simplifies the link by delivering a clean, narrow-linewidth, high-brightness beam. For advanced receivers, an RCS-tuned photodiode can synchronize with the transmitted pulses, gating only the desired wavelength and time window, reducing solar background and stray light by up to 10×, thereby improving sensitivity and bit error rates.

This RCS approach eliminates the need for separate spectral filters, pulse modulators, and external Q-switches, while also converting multimode high-power light into a single-mode, narrowband carrier. By concentrating multiple functions into one compact RCS element, the system minimizes mass and power consumption, making it ideal for low Earth orbit (LEO) constellations, interplanetary communication relays, and high-altitude airborne platforms where efficiency, reliability, and precision are critical.

This example discloses a Refractive Index Modulation (RIM) device configured for ultrafast, dynamic phase control of laser beams in coherent optical systems. The device comprises a porous piezoelectric material layer, such as GaN, AlN, or AlScGaN, engineered to exhibit an effective refractive index between 1.9 and 2.1 due to controlled porosification. A laser pulse is injected laterally through the porous layer, and the refractive index of the layer is actively modulated by applying either (i) an electric field across the layer, (ii) a surface acoustic wave (SAW) excitation generated by interdigital transducers, or (iii) another external energy source such as optical or RF activation.

Upon activation, the induced refractive index change (Δn) alters the optical path length of the traversing laser pulse, thereby introducing a programmable phase shift relative to a reference beam. The resulting phase difference is given by:

Δϕ=2πΔnL/λ

where L is the optical interaction length of the porous layer, λ is the operating wavelength, and Δn is dynamically tunable upon activation. The phase shift can be applied continuously for fine-tuning or discretely to introduce quantized phase steps.

The RIM device can function as: (1) a continuous phase modulator providing smooth phase adjustments with picosecond-scale precision for beam steering and optical interferometry; (2) a discrete phase shifter-enabling phase jumps for pulse coding, beamforming, or coherent optical communication; and a coherent beam combining element—where multiple high-power laser beams are combined into a single, phase-coherent output by dynamically matching their phases.

Current phase control technologies, including bulk electro-optic modulators, thermal phase shifters, and liquid-crystal devices are limited by slow response times (nanoseconds to milliseconds), low power handling, or large device footprints. The RIM device, by contrast, achieves sub-100 ps response times due to the fast SAW-induced and piezoelectric-driven modulation, supports high optical power owing to the robust III-nitride material system, and can be monolithically integrated into photonic circuits or external optical setups.

This combination of speed, power tolerance, and compact integration allows the RIM device to overcome the limitations of conventional phase control components, making it highly advantageous for applications such as phased-array laser systems, optical neural networks, quantum photonics, and ultrafast interferometry

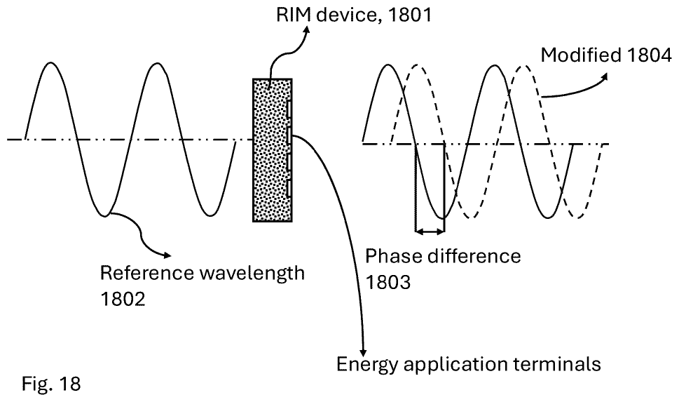

A schematic illustration of the phase-shifting mechanism is shown in FIG. 18, where an RIM device 1801 is illuminated by an input beam at a reference wavelength 1802. Upon activation of the RIM device, the output beam 1804 is phase-shifted relative to the reference wavelength, with the induced phase difference indicated as 1803.

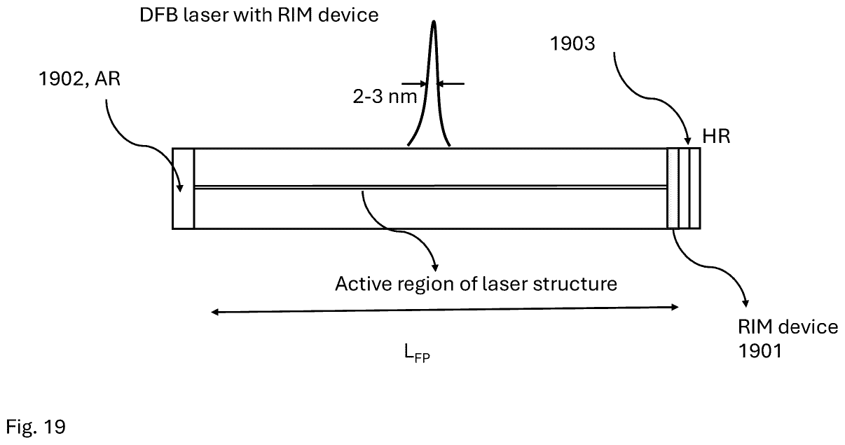

This example (see FIG. 19) describes a method and system for converting a standard Fabry-Perot (FP) semiconductor laser into a dynamically tunable, high-power single-mode source using a facet-mounted Refractive Index Modulation (RIM) device, 1901. The approach is applicable to all laser diodes based on III-V compound semiconductors, including but not limited to InGaN/GaN blue and violet lasers, AlGaInP red and orange lasers, and InGaAsP-based infrared lasers.

The FP gain medium uses a conventional double-heterostructure laser design grown epitaxially, such as by metal-organic chemical vapor deposition (MOCVD) or molecular beam epitaxy (MBE), on a suitable substrate. The typical stack comprises an n-type cladding layer (e.g., n-GaN, n-AlGaAs, or n-InP) for optical confinement and conduction, an n-type waveguide layer (InGaN, AlGaInP, or InGaAsP), a multiple-quantum-well (MQW) or bulk active region tuned to the target wavelength, a p-type waveguide layer, an electron-blocking layer (EBL) (such as AlGaN, AlInP, or AlGaAs) to confine carriers, and a p-type cladding layer (p-GaN, p-AlGaAs, or p-InP) with a doped contact layer for ohmic contact. Under forward bias, electrons and holes recombine in the active region, generating stimulated emission across a natural gain bandwidth (typically 2-5 nm for narrow MQW lasers).

After ridge processing, the device is cleaved into cavities ranging from 200 μm to 1 mm. The output facet is coated with an anti-reflective (AR) coating, 1902 (R≈0.2-0.3) to define output coupling, while the rear facet is coated with a high-reflective (HR) coating, 1903 (R≥0.9) for feedback. In this example, the rear facet is replaced by a broadband distributed Bragg reflector (DBR) stack, integrated with a Refractive Index Modulation (RIM) layer, 1901. The RIM is also used as a part of the outside cavity by placing it in front of the laser apart from the facet.

The RIM comprises of a nanoporous, piezoelectric material. For example, III-nitride thin film, such as GaN, AlN, or AlScGaN, typically 100-300 nm thick, deposited on a transparent carrier or directly onto the cleaved facet. Its refractive index is dynamically modulated via surface acoustic waves (SAWs) or electric fields or external energy applied across the porous layer. The nanopores deform and partially refill under excitation, causing an effective index shift Δn, which in turn induces a controllable phase shift Ao in the reflected wave. This phase tuning allows the RIM to selectively favor one longitudinal FP mode within the existing gain spectrum by satisfying the round-trip resonance condition:

mλ=2n_{eff}L_{FP}+ϕ_{RIM}

where m is the longitudinal mode index, L_{FP} is the cavity length, and n_{eff} is the effective refractive index (2.2-3.5 for III-V alloys). Only the selected FP mode achieves constructive interference, reaches threshold gain, and is amplified by the MQW gain region, while other FP modes remain below threshold despite reflection. The lasing output exits through the AR-coated front facet, delivering single-mode emission at high power, comparable to multi-mode FP devices but without the need for DFB gratings.

The RIM can rapidly step between FP modes within the natural gain bandwidth, each separated by the cavity free spectral range:

$$∇ {λ}_{FSR} = {λ}^{2} / 2 {n}_{eff} {L}_{FP}$$

For a 450 nm blue laser with n_{eff}≈2.5 and a 500 μm cavity, the free spectra range (FSR) is about 0.036 nm. For a 1550 nm InP-based laser with n_{eff}≈3.4 and a 1 mm cavity, the FSR is about 0.18 nm. The RIM can therefore sequentially select any FP mode supported by the gain spectrum (typically covering 2-5 nm), enabling rapid wavelength reassignment without thermal tuning or internal gratings.

The RIM device could be placed in front of the facet without being attached to the facet of the laser when an outside cavity is used.

This architecture simplifies fabrication by avoiding etched DFB gratings, relying solely on standard cleaving, AR/HR coatings, and external RIM integration. It enables sub-nanosecond, non-thermal phase tuning via SAWs or electric fields, eliminating the latency, thermal crosstalk, and power consumption typical of heater-based wavelength control. By providing agile mode selection within the gain bandwidth, the RIM-assisted FP laser delivers high-power, spectrally pure output suitable for dense wavelength-division multiplexing (DWDM), LiDAR, photonic processors, and optical neural networks.

This example discloses a system and method for generating single photons on demand by integrating a quantum dot-based resonant cavity light-emitting diode (RCLED) with a resonantly tunable optical switch based on a Resonant Cavity Switching (RCS) device. The architecture enables temporal and spectral control over single-photon release with sub-nanosecond precision.

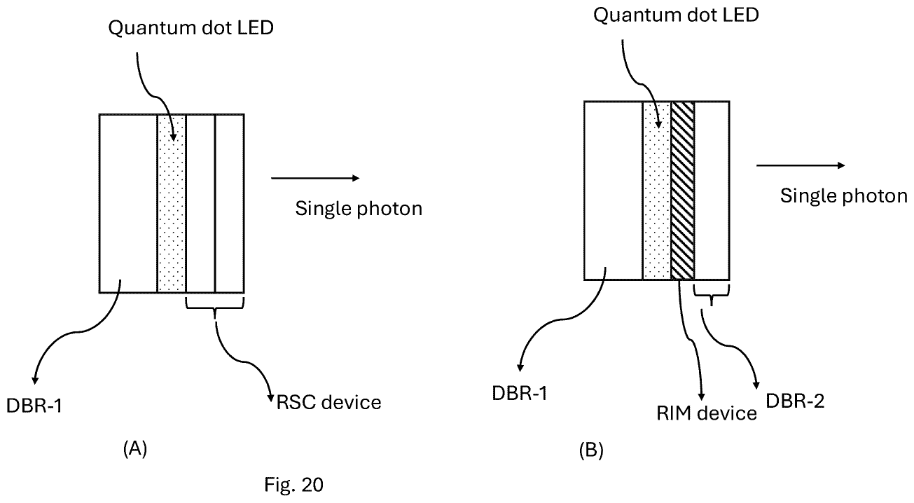

As illustrated in FIG. 20, two configurations are proposed: (A) a resonant cavity structure utilizing an RCS device, and (B) a refractive index modulation (RIM) device. In configuration (A), the system comprises a main optical cavity bounded on one end by a high-reflectivity dielectric distributed Bragg reflector (DBR-1), and on the opposite end by a tunable RCS device. The RCS device includes a nanoporous piezoelectric material, such as GaN, AlN, AlGaN, GaAlScN, or AlScN, integrated within a high-Q optical microcavity structure. The refractive index of this material can be modulated using surface acoustic waves (SAWs), applied electric fields, or other forms of external energy. This index modulation dynamically shifts the RCS cavity into or out of resonance with the main cavity, effectively functioning as a high-speed optical gate.

Located within the main cavity is a quantum-dot-based RCLED. The active region of the RCLED comprises one or more quantum dots embedded within a thin-film III-nitride or conventional III-V compound host matrix, providing three-dimensional carrier confinement. These quantum dots are engineered to support discrete exciton generation events which, under proper biasing conditions, result in the emission of a single photon per excitation cycle. Excitation of the quantum dot may be achieved either electrically via lateral or vertical contacts or optically, using sub-picosecond pump pulses delivered through a transparent section of the DBR.

During operation, the quantum dot is selectively excited by a trigger signal, producing a single exciton that recombines radiatively within the high-Q RCLED cavity. The resulting emission is spectrally and directionally confined by the cavity resonance, enhancing photon extraction efficiency through the Purcell effect. However, the photon remains confined within the main cavity until the RCS device is dynamically tuned into resonance with the emitted photon's wavelength. Once spectral alignment is achieved, the RCS device becomes transmissive through dynamic wavelength matching, enabling the precise release of a single photon with sub-nanosecond temporal control.

In the alternative configuration (B), shown in FIG. 20, a refractive index modulation (RIM) device is placed before the second DBR mirror (DBR-2) of the cavity. In this setup, the quantum dot is excited by external means, and the RIM device is tuned such that the optical phase of the traveling photon in the cavity (between DBR-1 and DBR-2) is adjusted to satisfy the resonance condition. This dynamic phase tuning facilitates controlled release of the single photon through resonance matching, thereby achieving the same functional outcome as the RCS-based configuration.

Also, both of RCS and RIM devices could be used at the same time together with RCLED to obtain a single photon emission by resonating the wavelength and phase of the emission of RCLED.

The system can operate using either electrically conducting DBRs allowing for electrical injection into the quantum dots or dielectric DBRs, which permit optical pumping. In both configurations, precise tunability and timing control are achieved using either the RCS device or the RIM device.

This controlled release mechanism enables deterministic, sub-nanosecond single-photon emission, facilitating integration into quantum communication systems, quantum key distribution (QKD) networks, and photonic quantum computing platforms. The resonant tuning mechanism is non-thermal and compatible with high-speed modulation rates, offering significant advantages over conventional filter-based or electrically gated single-photon sources.

In some examples, the RCS device may be actuated using surface acoustic waves (SAWs) or other external energy sources, launched from interdigital transducers (IDTs) fabricated on the piezoelectric surface of the RCS device. In other examples, refractive index modulation may be achieved through pulsed electric field applied across the nanoporous piezoelectric layer, producing rapid optical path length changes sufficient to bring the cavity into resonance.

While the use of a quantum dot emitter ensures the generation of one and only one photon per excitation cycle, other single-photon sources such as nitrogen-vacancy (NV) centers in diamond may also be employed. The combination of deterministic photon generation with dynamic resonant extraction makes the disclosed system a highly reliable and tunable single-photon source with programmable spectral and temporal characteristics.

In an example, the device may be integrated into Fabry Perot cavities formed at the facet of solid-core or hollow-core optical fibers, or fabricated as suspended membranes on planar substrates for use in AR/VR, LiDAR, TV, projector, quantum optics, photonic neural networks, communication and remote ignition systems. In an example, scalable implementations include 1D or 2D arrays for spatial multiplexing, beam steering, and coordinated multi-channel output. The invention provides a compact, ultrafast, and versatile platform for dynamic optical control across a broad range of photonic applications.

In an example, the present invention provides one or more of the following examples.

In an example, the present invention provides a resonant cavity switching device (RCS). The device has a first distributed Bragg reflector (DBR) mirror comprising a first distributed Bragg reflector (DBR) stack with a high reflectivity and a second DBR mirror comprising a second DBR stack with a lower reflectivity than the high reflectivity of the first DBR mirror. In an example, the device has a cavity region comprising a plurality of voids and made of a piezo electric material and sandwiched by the first DBR mirror and the second DBR mirror. In an example, the device has a light incident onto a surface of the first DBR stack such that the light is irradiated into the first DBR mirror such that at least a portion of the light is extracted from the second DBR mirror by applying an energy into the cavity region.

In an example, the high reflectivity of the first DBR is more than 95%. In an example, the energy causes a change in collective reflectivity of the RCS device from the high reflectivity, e.g., of more than 95% to a reflectivity of 20% and less.

In an example, the energy causes a change in collective reflectivity of the RCS device from the high reflectivity, e.g., of more than 95% to a reflectivity of 20% and less, such that the portion of the light traverses through the first DBR stack, the piezoelectric material cavity region, and the second DBR stack.

In an example, the RCS device is configured as a wavelength filter. In an example, the RCS device is configured as an optical switch or other devices.

In an example, the voids comprise a nanoporous structure, and variations. In an example, the DBR is composed of a plurality of dielectric materials selected from at least one of a silicon dioxide (SiO₂), a titanium dioxide (TiO₂), a tantalum oxide (Ta₂O₅), a Ti doped Ta₂O₅, or a hafnium oxide (HfO₂) or other materials.

In an example, the cavity region is characterized by a thickness of (2m+1) \/2nzero without the energy and (2m+1) λ/2nr with the energy where m is an integer of m=0, 1, 2, and greater, and where λ is an operating wavelength, and nzero and nr is an effective refractive index without and with energy into the cavity region, respectively.

In an example, the cavity region comprises one or more acoustic actuation elements or one or more electrical actuation elements integrated with the cavity region to induce dynamic tuning of an optical resonance. In an example, the voids comprise at least two.

In an example, the light is generating from a light source including at least one of a light emitting diode (LED), a laser or a white light or other types of electromagnetic radiation.

In an example, the RCS device is configured to control an intensity of the light emitted by an LED or a laser or a switching of the light emitted by an LED or a laser.

In an example, the RCS device is adapted for a display by controlling an intensity of a red, a green or a blue (RGB) light emitted by an LED or a laser diode (LDs) or a combination of phosphors coupled to the LED or the LD or other light sources.

In an example, the RCS device is coupled to an optical link for optical communications or transmission.

In an example, the RCS device separates an emission wavelength of an LED or a laser to achieve a multi-frequencies or multi-wavelengths communication. In an example, the RCS device sends a signal by controlling an intensity, a switching, a timing, a pulse shaping or a frequency of the light emitted by an LED or a laser. In an example, the RCS device receives a signal by selecting a certain wavelength or a spectrum by tuning the RCS device. In an example, the RCS device is provided for a pulse shaping of the light from a laser. In an example, the RCS device is provided to extract a laser beam from the Fabry-Perot cavity by synchronizing with a sensor.

In an example, the RCS device is provided as a filter to select a wavelength or a spectrum.

In an example, the device has an actuation element comprising a surface (SAW) or a bulk acoustic wave (BAW) generator, an interdigital transducers (IDTs), or a piezoelectric electrode, configured to modulate a refractive index of the cavity region.

In an example, the RCS device is provided for a deterministic single-photon release in a quantum communication device. In an example, the RCS device is characterized by a response time faster than 1,000 nanoseconds. In an example, the RCS device is characterized by a response time faster than 10 nanoseconds. In an example, the RCS is integrated into an optical fiber or a Si photonic circuit. In an example, the RCS is configured to form a Fabry Perot cavity to perform at least one of extract an enhanced pulsed laser, a pulse shaping, separating an emission wavelength, an optical filter, an optical switch, or controlling intensity of the light.

In an example, the device has a modulated aperture region comprising a membrane.

In an example, the RCS device is configured to operate across a wavelength range in an UV, a visible, a near-IR range, or a 300 nm-3000 nm spectra.

In an example, the RCS device is provided for a multi wavelength communication in a free space or through a fiber including a wavelength-division multiplexing (WDM) communication. In an example, the RCS device is provided in an application selected from an AI datacenter application, a drone, a robotic, a quantum computing, a neuromorphic, a AR/VR, a projection, a medical, a wireless or a fiber communication, a satellite communication application or a single photon source. In an example, the RCS device comprises an architecture in turning a multimode wavelengths laser to a single mode laser.

In an example, the piezoelectric material comprises a III-nitride material selected from GaN, AlN, InN, AlScN, GaScN, AlGaScN or their alloys, among other materials.

In an example, the plurality of voids is formed by exposing to elevated temperature using a thermal annealing.

In an example, the present invention provides a refractive index modulating (RIM) device. The device has a void-containing a piezoelectric material wherein at least effective refractive index is changed by applying an energy into the void containing piezoelectric material.

In an example, the void-containing piezoelectric material comprises a plurality of nanoporous regions.

In an example, the RIM device is provided for a phase shift of the light or a single mode laser or a single photon emission.

In an example, the piezoelectric material comprises a III-nitride material selected from GaN, AlN, InN, AlScN, GaScN, AlGaScN or their alloys, among others.

In an example, the present invention provides a method of fabricating a tunable mirror device. The method includes depositing a cavity layer via epitaxy, physical vapor deposition (PVD), or sputtering. The method includes forming voids or porosity in the cavity layer. The method includes sandwiching the porous layer between a first DBR and a second DBR of asymmetric reflectivity and forming an electrical contact structure on or near the porous layer.

While the above is a full description of the specific examples, various modifications, alternative constructions, and equivalents may be used. As an example, the present system, method, and device can include any combination of elements described above, as well as outside of the present specification. Additionally, the terms first, second, third, and final do not imply order in one or more of the present examples. Therefore, the above description and illustrations should not be taken as limiting the scope of the present invention which is defined by the appended claims.

### REFERENCES

[1] Backus, Sterling, et al. “High power ultrafast lasers.” Review of scientific instruments 69.3 (1998): 1207-1223.
[2] P. Lodahl et al., “Quantum-dot based photonic quantum networks, Quantum Sci. Technol. 3 (2018) 013001.
[3] Li, W.; Shi, T.; Wang, R.; Yang, J.; Ma, Z.; Zhang, W.; Fu, H.; Guo, P. Advances in LiDAR Hardware Technology: Focus on Elastic LiDAR for Solid Target Scanning. Sensors 2024, 24, 7268.
[4] Kurosaka, Y., Iwahashi, S., Liang, Y. et al. On-chip beam-steering photonic-crystal lasers. Nature Photon 4, 447-450 (2010).
[5] Salter, Patrick S., and Martin J. Booth. “Adaptive optics in laser processing.” Light: Science & Applications 8.1 (2019): 110.
[6] Bogaerts, W., Pérez, D., Capmany, J. et al. Programmable photonic circuits. Nature 586, 207-216 (2020).
[7] Paldus, Barbara A., and Alexander A. Kachanov. “An historical overview of cavity-enhanced methods.” Canadian Journal of Physics 83.10 (2005): 975-999.
[8] Wang, C., Zhang, M., Chen, X. et al. Integrated lithium niobate electro-optic modulators operating at CMOS-compatible voltages. Nature 562, 101-104 (2018)
[9] Tran, Chieu D. “Acousto-optic devices.” Analytical chemistry 64.20 (1992): 971A-981A.
[10] Thomson, David, et al. “Roadmap on silicon photonics.” Journal of Optics 18.7 (2016): 073003.
[11] Wang, H.; Zhang, L.; Zhou, Z.; Lou, L. Temperature Performance Study of SAW Sensors Based on AlN and AlScN. Micromachines 2023, 14, 1065.
[12] Muth J F, Brown J D, Johnson M A L, et al. Absorption Coefficient and Refractive Index of GaN, AlN and AlGaN Alloys. MRS Internet Journal of Nitride Semiconductor Research. 1999; 4 (S1): 502-507.
[13] Appl. Phys. Lett. 126, 041901 (2025)

1. A resonant cavity switching device (RCS) comprising:
a first distributed Bragg reflector (DBR) mirror comprising a first distributed Bragg reflector (DBR) stack with a high reflectivity;
a second DBR mirror comprising a second DBR stack with a lower reflectivity than the high reflectivity of the first DBR mirror;
a cavity region comprising a plurality of voids and made of a piezo electric material and sandwiched by the first DBR mirror and the second DBR mirror;
a light incident onto a surface of the first DBR stack such that the light is irradiated into the first DBR mirror such that at least a portion of the light is extracted from the second DBR mirror by applying an energy into the cavity region.

2. The device of claim 1 wherein the high reflectivity of the first DBR is more than 95%.

3. The device of claim 1 wherein the energy causes a change in collective reflectivity of the RCS device from the high reflectivity of more than 95% to a reflectivity of 20% and less.

4. The device of claim 1 wherein the energy causes a change in collective reflectivity of the RCS device from the high reflectivity of more than 95% to a reflectivity of 20% and less such that the portion of the light traverses through the first DBR stack, the piezoelectric material cavity region, and the second DBR stack.

5. The device of claim 1 wherein the RCS device is configured as a wavelength filter.

6. The device of claim 1 wherein the RCS device is configured as an optical switch.

7. The device of claim 1 wherein the voids comprise a nanoporous structure.

8. The device of claim 1, wherein the DBR is composed of a plurality of dielectric materials selected from at least one of a silicon dioxide (SiO₂), a titanium dioxide (TiO₂), a tantalum oxide (Ta₂O₅), a Ti doped Ta₂O₅, or a hafnium oxide (HfO₂).

9. The device of claim 1, wherein the cavity region is characterized by a thickness of (2m+1)λ/2n_{zero} without the energy and (2m+1)λ/2nᵣ with the energy where m is an integer of m=0, 1, 2, and greater, and where A is an operating wavelength, and n_{zero} and nᵣ is an effective refractive index without and with energy into the cavity region, respectively.

10. The device of claim 1, wherein the cavity region comprises one or more acoustic actuation elements or one or more electrical actuation elements integrated with the cavity region to induce dynamic tuning of an optical resonance.

11. The device of claim 1, wherein the voids comprise at least two.

12. The device of claim 1, wherein the light is generating from a light source including at least one of a light emitting diode (LED), a laser or a white light.

13. The device of claim 1, wherein the RCS device is configured to control an intensity of the light emitted by an LED or a laser or a switching of the light emitted by an LED or a laser.

14. The device of claim 13, wherein the RCS device is adapted for a display by controlling an intensity of a red, a green or a blue (RGB) light emitted by an LED or a laser diode (LDs) or a combination of phosphors coupled to the LED or the LD.

15. The device of claim 1, wherein the RCS device is coupled to an optical link.

16. The device of claim 1, wherein the RCS device separates an emission wavelength of an LED or a laser to achieve a multi-frequencies or multi-wavelengths communication.

17. The device of claim 1, wherein the RCS device sends a signal by controlling an intensity, a switching, a timing, a pulse shaping or a frequency of the light emitted by an LED or a laser.

18. The device of claim 1, wherein the RCS device receives a signal by selecting a certain wavelength or a spectrum by tuning the RCS device.

19. The device of claim 1, wherein the RCS device is provided for a pulse shaping of the light from a laser.

20. The device of claim 1, wherein the RCS device is provided to extract a laser beam from the Fabry-Perot cavity by synchronizing with a sensor.

21. The device of claim 1, wherein the RCS device is provided as a filter to select a wavelength or a spectrum.

22. The device of claim 1, further comprising an actuation element comprising a surface (SAW) or a bulk acoustic wave (BAW) generator, an interdigital transducers (IDTs), or a piezoelectric electrode, configured to modulate a refractive index of the cavity region.

23. The device of claim 1, wherein the RCS device is provided for a deterministic single-photon release in a quantum communication device.

24. The device of claim 1, wherein the RCS device is characterized by a response time faster than 1,000 nanoseconds.

25. The device of claim 1, wherein the RCS device is characterized by a response time faster than 10 nanoseconds.

26. The device of claim 1, wherein the RCS is integrated into an optical fiber or a Si photonic circuit.

27. The device of claim 1, wherein the RCS is configured to form a Fabry Perot cavity to perform at least one of extract an enhanced pulsed laser, a pulse shaping, separating an emission wavelength, an optical filter, an optical switch, or controlling intensity of the light.

28. The device of claim 1, further comprising a modulated aperture region comprising a membrane.

29. The device of claim 1, wherein the RCS device is configured to operate across a wavelength range in an UV, a visible, a near-IR range, or a 300 nm-3000 nm spectra.

30. The device of claim 1, wherein RCS device is provided for a multi wavelength communication in a free space or through a fiber including a wavelength-division multiplexing (WDM) communication.

31. The device of claim 1, wherein RCS device is provided in an application selected from an AI datacenter application, a drone, a robotic, a quantum computing, a neuromorphic, a AR/VR, a projection, a medical, a wireless or a fiber communication, a satellite communication application or a single photon source.

32. The device of claim 1, wherein RCS device comprises an architecture in turning a multimode wavelengths laser to a single mode laser.

33. The device of claim 1, wherein the piezoelectric material comprises a III-nitride material selected from GaN, AlN, InN, AlScN, GaScN, AlGaScN or their alloys.

34. The device of claim 1, wherein the plurality of voids is formed by exposing to elevated temperature using a thermal annealing.

35. A refractive index modulating (RIM) device comprising:
a void-containing a piezoelectric material wherein at least effective refractive index is changed by applying an energy into the void containing piezoelectric material.

36. The device of claim 35, wherein the void-containing piezoelectric material comprises a plurality of nanoporous regions.

37. The device of claim 35, wherein the RIM device is provided for a phase shift of the light or a single mode laser or a single photon emission.

38. The device of claim 35, wherein the piezoelectric material comprises a III-nitride material selected from GaN, AlN, InN, AlScN, GaScN, AlGaScN or their alloys.

39. A method of fabricating a tunable mirror device, comprising:
depositing a cavity layer via epitaxy, physical vapor deposition (PVD), or sputtering;
forming voids or porosity in the cavity layer;
sandwiching the porous layer between a first DBR and a second DBR of asymmetric reflectivity; and
forming an electrical contact structure on or near the porous layer.
